(19) United States
(12) Patent Application Publication
(10) Pub. No.: US 2026/0027585 A1
(43) Pub. Date: Jan. 29, 2026

(54) NOVEL CAPACITIVE MICROMACHINED ULTRASONIC TRANSDUCER AND CONTROL METHOD

(71) Applicant: Huazhong University of Science and Technology, Wuhan City (CN)

(72) Inventors: Bo MA, Wuhan City (CN); Zheng YOU, Wuhan City (CN)

(21) Appl. No.: 19/021,392

(22) Filed: Jan. 15, 2025

(30) Foreign Application Priority Data
Jul. 23, 2024 (CN) 202410993362.9

(51) Int. Cl. B06B 1/02

(52) U.S. Cl. CPC B06B 1/0292

(57) ABSTRACT

A novel capacitive micromachined ultrasonic transducer (CMUT) and a control method are provided. The novel CMUT includes a substrate, a plurality of chambers provided on the substrate, and a plurality of resonant plates. The resonant plate is at least disposed at a top of each chamber, upper and lower adjacent chambers share a resonant plate, at least two of the plurality of chambers have different heights in a natural state, and/or, at least one of the resonant plates shared by the upper and lower adjacent chambers is capable of deforming. In this way, in the scenario of receiving an ultrasonic signal, the chamber with a relatively small height in a natural state or after deformation may serve as a receiving chamber, and in the scenario of sending the ultrasonic signal, the chamber with a relatively large height in the natural state or after deformation may serve as a sending chamber.

### CROSS REFERENCE TO RELATED APPLICATION

This patent application claims the benefit and priority of Chinese Patent Application No. 2024109933629, filed with the China National Intellectual Property Administration on Jul. 23, 2024, the disclosure of which is incorporated by reference herein in its entirety as part of the present application.

### TECHNICAL FIELD

The present disclosure relates to the technical field of micro-nano sensing devices, and in particular, to a novel capacitive micromachined ultrasonic transducer (CMUT) and a control method.

### BACKGROUND

The capacitive micromachined ultrasonic transducer (CMUT) has high sensitivity, high output sound pressure, wide bandwidth, easy large-scale manufacturing, and easily integrated with an specific integrated circuit (ASIC), has been widely used in medical imaging diagnosis and treatment, high-intensity focused ultrasound (HIFU), handheld personal medical ultrasound equipment, chemical sensing, and airborne applications, and has become a powerful alternative to a piezoelectric transducer. The conventional CMUT includes a resonant plate and two electrodes, and a vacuum chamber which is formed between the electrodes to form a variable capacitor as an electromechanical transformer. Therefore, the performance of the conventional CMUT, such as output sound pressure, receiving sensitivity, and driving voltage, are all limited by the chamber height. The lower the chamber height, the higher the receiving sensitivity and the lower the driving voltage, but the resonance amplitude and the output sound pressure are significantly limited. Increasing the chamber height can increase the output sound pressure, but will result in a decrease in receiving sensitivity and an increase in driving voltage.

### SUMMARY

An objective of the present disclosure is to provide a novel capacitive micromachined ultrasonic transducer (CMUT) and a control method, to improve the receiving sensitivity while increasing the output sound pressure.

To achieve the above objective, the present disclosure provides the following solutions:

In a first aspect, embodiments of the present disclosure provide a novel CMUT, including a substrate, a plurality of chambers provided on the substrate, and a plurality of resonant plates, where the resonant plate is at least disposed at a top of each chamber, upper and lower adjacent chambers share a resonant plate, at least two of the plurality of chambers have different heights in a natural state, and/or, at least one of the resonant plates shared by the upper and lower adjacent chambers is capable of deforming.

In a second aspect, the embodiments of the present disclosure provide a control method for a novel CMUT, where on the basis of the novel CMUT,
the control method includes:
during signal reception, providing a direct-current bias voltage at least to a chamber configured to receive an ultrasonic signal, where the chamber configured to receive the ultrasonic signal is a receiving chamber, and among the plurality of chambers, a height of at least one chamber in a natural state is not less than a height of the receiving chamber in the natural state, and/or, during signal reception, the height of the receiving chamber is less than the height of the receiving chamber in the natural state due to deformation of the resonant plate; and
during signal sending, providing a driving signal at least to a chamber configured to send an ultrasonic signal, where the chamber configured to send the ultrasonic signal is a sending chamber, and among the plurality of chambers, the height of at least one chamber in the natural state is not greater than a height of the sending chamber in the natural state, and/or, during signal sending, the height of the sending chamber is greater than the height of the sending chamber in the natural state due to deformation of the resonant plate.

According to specific embodiments provided in the present disclosure, the present disclosure has the following technical effects:

In the multi-chamber structure provided by the embodiments of the present disclosure, at least one of the resonant plates shared by the upper and lower adjacent chambers is capable of deforming, the deformation of the resonant plate can cause the height changes of the upper and lower adjacent chambers, and the upper and lower adjacent chambers also deform. In some deformation states, the heights of the upper and lower adjacent chambers may be different. For a same chamber, different deformation directions may cause the height of the chamber to increase or decrease compared with the height of the chamber in the natural state. And/or, in the multi-chamber structure, at least two chambers have different heights in the natural state. In this way, in the scenario of receiving an ultrasonic signal, the chamber with a relatively small height in a natural state or after deformation serves as a receiving chamber, and in the scenario of sending the ultrasonic signal, the chamber with a relatively large height in the natural state or after deformation serves as a sending chamber, thereby solving the contradictions in conventional devices that reducing the height of the chamber can improve the receiving sensitivity but limit the resonant amplitude and the output sound pressure, and increasing the height of the chamber can increase the output sound pressure but reduce the receiving sensitivity and increase the driving voltage. Therefore, the novel CMUT provided in the embodiments of the present disclosure can improve the receiving sensitivity while increasing the output sound pressure.

### BRIEF DESCRIPTION OF THE DRAWINGS

FIG. 1 is a schematic structural diagram of an existing CMUT;

FIGS. 2A-2B are schematic diagrams of a multi-resonant-plate, multi-chamber and multi-electrode structure of a CMUT according to embodiments of the present disclosure;

FIGS. 3A-3D are schematic structural diagrams of a CMUT in which a substrate uses a 3D conformal electrode design according to embodiments of the present disclosure;

FIGS. 4A-4B are schematic structural diagrams of a CMUT in which a resonant plate uses a 3D conformal electrode design according to embodiments of the present disclosure;

FIGS. 5A-5B are schematic structural diagrams of a CMUT in which a substrate and a main resonant plate synchronously use a 3D conformal electrode design according to embodiments of the present disclosure;

FIG. 6 is a schematic structural diagram of a CMUT in which gas squeeze-film damping is introduced through a micro through hole according to embodiments of the present disclosure;

FIG. 7 is a schematic structural diagram of a CMUT in which gas squeeze-film damping is regulated through microfluidic channels according to embodiments of the present disclosure;

FIG. 8 is a schematic diagram of microfluidic channels and distribution of integrated micro-pillar arrays and fan-shaped microstructures according to embodiments of the present disclosure;

FIG. 9 is a schematic structural diagram of a CMUT in which gas squeeze-film damping is regulated through a hollowed resonant plate according to embodiments of the present disclosure;

FIG. 10 is a schematic diagram of a hollowed structure and distribution according to embodiments of the present disclosure;

FIG. 11 is a schematic structural diagram of a CMUT in which gas squeeze-film damping is regulated through a through hole, microfluidic channels, and a hollowed structure according to embodiments of the present disclosure;

FIG. 12 is a schematic structural diagram of a CMUT synchronously having gas squeeze-film damping regulation microstructures and a 3D conformal electrode according to embodiments of the present disclosure;

FIG. 13 is a schematic diagram of a dual-electrode configuration in a normal mode according to embodiments of the present disclosure;

FIG. 14 is a schematic diagram of an electrode configuration when a CMUT operates in a normal mode as a receiver according to embodiments of the present disclosure;

FIG. 15 is a schematic diagram of a multi-electrode parallel configuration in a normal mode according to embodiments of the present disclosure;

FIG. 16 is a schematic diagram of a driving configuration when a CMUT operates in a normal mode as a sender according to embodiments of the present disclosure;

FIG. 17 is a schematic diagram of a multi-electrode series configuration in a normal mode according to embodiments of the present disclosure;

FIG. 18 is a schematic diagram of an electrode configuration of dual-chamber reception in a normal mode according to embodiments of the present disclosure;

FIG. 19 is a schematic diagram of an electrode configuration of dual-plate resonance in a normal mode according to embodiments of the present disclosure;

FIG. 20 is a schematic diagram of a pulse sequence driving signal according to embodiments of the present disclosure;

FIG. 21 is a schematic diagram of an electrode configuration when a CMUT serves as a receiver and a main resonant plate operates in a collapse mode according to embodiments of the present disclosure;

FIG. 22 is a schematic diagram of an electrode configuration when a CMUT serves as a sender and slave resonant plates operate in a collapse mode according to embodiments of the present disclosure;

FIG. 23 is a schematic diagram of an electrode configuration when main and slave resonant plates of a CMUT all operate in a collapse mode according to embodiments of the present disclosure;

FIG. 24 is a schematic diagram of an electrode configuration when main and slave resonant plates of a CMUT, which uses a 3D conformal electrode design, all operate in a collapse mode according to embodiments of the present disclosure;

FIG. 25 is a schematic diagram of an electrode configuration when main and slave resonant plates of a CMUT, which uses a 3D conformal electrode design and introduces gas squeeze-film damping regulation microstructures, all operate in a collapse mode according to embodiments of the present disclosure;

FIG. 26 is a schematic diagram of a pull-in voltage effect according to embodiments of the present disclosure;

FIG. 27 is a schematic structural diagram of a CMUT in which a resonant plate is made of different materials according to embodiments of the present disclosure;

FIG. 28 is a schematic diagram showing that a 3D conformal surface of a substrate has a consistent structural morphology with deformed slave resonant plates according to embodiments of the present disclosure;

FIG. 29 is a schematic diagram of a receiving sensitivity after gas squeeze-film damping regulation is introduced when a CMUT operates in a normal mode according to embodiments of the present disclosure;

FIG. 30 is a schematic diagram of a sending sensitivity after gas squeeze-film damping regulation is introduced when a CMUT operates in a normal mode according to embodiments of the present disclosure;

FIG. 31 is a schematic diagram of a output sound pressure of same-frequency dual-resonance of main and slave resonant plates when a CMUT operates in a normal mode according to embodiments of the present disclosure;

FIG. 32 is a schematic diagram of a receiving sensitivity when slave resonant plates of a CMUT operate in a collapse mode according to embodiments of the present disclosure;

FIG. 33 is a schematic diagram of a output sound pressure when slave resonant plates of a CMUT operate in a collapse mode according to embodiments of the present disclosure;

FIG. 34 is a structural schematic diagram of a CMUT having micro-nano stacked chambers according to embodiments of the present disclosure;

FIG. 35 is a structural schematic diagram of a CMUT having a plurality of nano-chambers arranged side by side according to embodiments of the present disclosure;

FIG. 36 is a schematic diagram of a multi-electrode parallel configuration when a CMUT having micro-nano stacked chambers operate in a normal mode according to embodiments of the present disclosure;

FIG. 37 is a schematic diagram of a multi-electrode series configuration when a CMUT having micro-nano stacked chambers operate in a normal mode according to embodiments of the present disclosure;

FIG. 38 is a schematic diagram of an electrode configuration when a CMUT having micro-nano stacked chambers operate in a normal mode as a receiver according to embodiments of the present disclosure;

FIG. 39 is a schematic diagram of an electrode configuration when a CMUT having micro-nano stacked chambers operate in a normal mode as a sender according to embodiments of the present disclosure;

FIG. 40 is a schematic diagram of a CMUT having a 3D conformal insulating layer in stacked nano-chambers according to embodiments of the present disclosure;

FIG. 41 is a schematic structural diagram of a CMUT having a 3D conformal electrode on a substrate of a stacked micro-chamber according to embodiments of the present disclosure;

FIG. 42 is a schematic diagram of a CMUT having a micro through hole on a substrate of a stacked micro-chamber according to embodiments of the present disclosure;

FIG. 43 is a schematic structural diagram of a CMUT having microfluidic channels on a substrate of a stacked micro-chamber according to embodiments of the present disclosure;

FIG. 44 is a schematic structural diagram of a CMUT which has a 3D conformal electrode on a substrate of a stacked micro-chamber and introduces microfluidic channels to regulate gas squeeze-film damping according to embodiments of the present disclosure;

FIG. 45 is a structural schematic diagram when a stacked nano-chamber operates in a collapse mode according to embodiments of the present disclosure;

FIG. 46 is a schematic diagram when a stacked micro-chamber and a stacked nano-chamber synchronously operate in a collapse mode according to embodiments of the present disclosure;

FIG. 47 is a schematic structural diagram when a stacked micro-chamber and a stacked nano-chamber, which respectively have a 3D conformal electrode, synchronously operate in a collapse mode according to embodiments of the present disclosure;

FIG. 48 is a schematic structural diagram when a stacked micro-chamber and a stacked nano-chamber, which respectively have a 3D conformal electrode and have microfluidic channels for regulating gas squeeze-film damping, synchronously operate in a collapse mode according to embodiments of the present disclosure;

FIG. 49 is a schematic structural diagram showing that a micro-chamber is divided into a plurality of nano-chambers arranged in series according to embodiments of the present disclosure;

FIG. 50 is a schematic diagram of a multi-electrode configuration of a CMUT shown in FIG. 49;

FIG. 51 is a schematic diagram showing that a micro-chamber is divided into rectangular mesh cascaded chambers according to embodiments of the present disclosure;

FIG. 52 is a schematic diagram showing that a micro-chamber is divided into curved mesh cascaded chambers according to embodiments of the present disclosure;

FIG. 53 is a schematic diagram showing that nano-chambers are arranged side by side and a micro-chamber is divided into a plurality of cascaded hybrid nano-chambers according to embodiments of the present disclosure;

FIG. 54 is another schematic diagram showing that nano-chambers are arranged side by side and a micro-chamber is divided into rectangular mesh cascaded hybrid chambers according to embodiments of the present disclosure;

FIG. 55 is another schematic diagram showing that nano-chambers are arranged side by side and a micro-chamber is divided into curved mesh cascaded hybrid chambers according to embodiments of the present disclosure;

FIG. 56 is a schematic diagram of a receiving sensitivity of a micro-chamber and a nano-chamber when a CMUT operates in a normal state according to embodiments of the present disclosure;

FIG. 57 is a schematic diagram of a output sound pressure of a micro-chamber and a nano-chamber when a CMUT operates in a normal state according to embodiments of the present disclosure;

FIG. 58 is a schematic diagram of a receiving sensitivity when a CMUT having a plurality of nano-chambers arranged side by side operates in a normal state according to embodiments of the present disclosure;

FIG. 59 is a schematic diagram of a output sound pressure when a CMUT having a plurality of nano-chambers arranged side by side operate in a normal mode according to embodiments of the present disclosure; and

FIG. 60 is a schematic diagram of a sensitivity comparison between a conventional planar electrode and a 3D curved conformal electrode according to embodiments of the present disclosure.

### DETAILED DESCRIPTION OF THE EMBODIMENTS

The technical solutions in the embodiments of the present disclosure will be clearly and completely described below with reference to the drawings in the embodiments of the present disclosure.

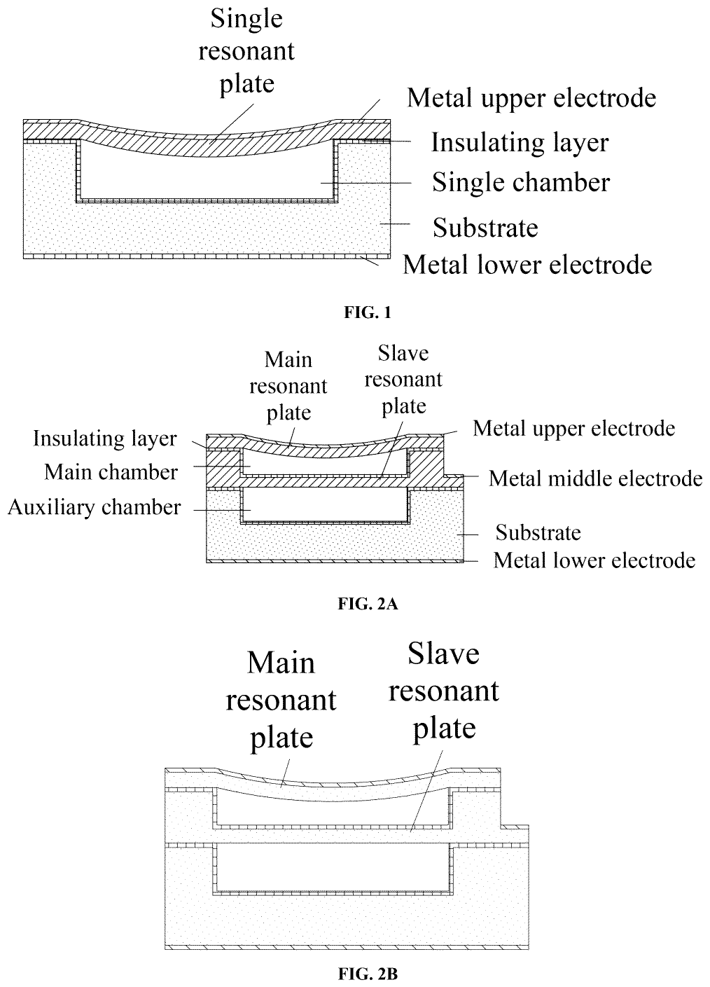

Refer to FIG. 1, the conventional CMUT includes a resonant plate and two electrodes, and a vacuum chamber is formed between the electrodes to form a variable capacitor to implement electromechanical conversion. Therefore, the core performance of the conventional CMUT, such as output sound pressure, receiving sensitivity, and driving voltage, are all limited by the chamber height. The smaller the chamber height, the higher the receiving sensitivity and the lower the driving voltage, but the resonance amplitude and the output sound pressure are significantly limited. Increasing the chamber height can increase the output sound pressure, but will result in a decrease in receiving sensitivity and an increase in driving voltage.

For this purpose, the objective of the embodiments of the present disclosure is to provide a novel CMUT and a control method for the novel CMUT (hereinafter referred to as a control method), to improve the receiving sensitivity while increasing the output sound pressure.

The novel CMUT (hereinafter referred to as a novel CMUT or a CMUT) at least includes a substrate and a multi-chamber structure located on the substrate, where the multi-chamber structure includes a plurality of chambers and a plurality of resonant plates.

The number of the plurality of chambers and the number of the plurality of resonant plates not less than two, and can be flexibly designed according to requirements by those skilled in the art, which will not be repeated herein.

The shape of the chambers is not limited to a polygon such as a circle, a square, an ellipse, a rectangle, a pentagon, a hexagon, and an octagon. Correspondingly, the shape of the resonant plates is not limited to a polygon such as a circle, a square, an ellipse, a rectangle, a pentagon, a hexagon, and an octagon.

For the novel CMUT, a plurality of electrode configuration modes and a plurality of control methods can be designed, where some electrode configuration modes can separate sending and receiving functions. A plurality of electrode configurations can be used in a normal operating mode and a collapse operating mode, which will be introduced below.

The chambers and the resonant plates are introduced below.

In the novel CMUT, a resonant plate is provided between the upper and lower adjacent chambers, and a resonant plate is at least provided at a top of each chamber. Or, the plurality of resonant plates in the novel CMUT include a resonant plate provided between every two adjacent chambers and a resonant plate provided at the top.

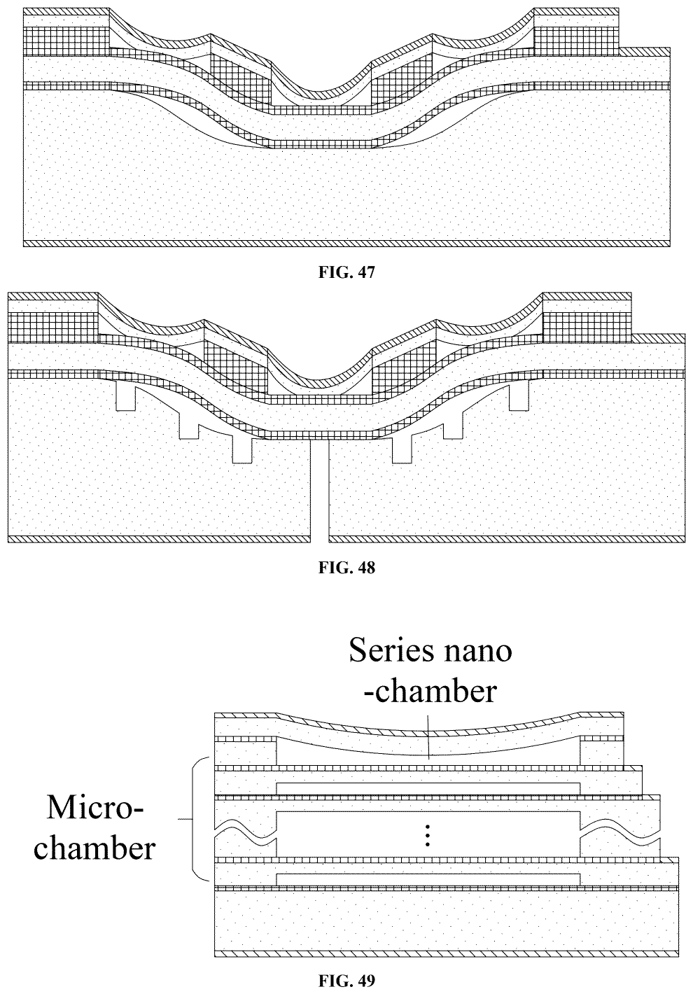

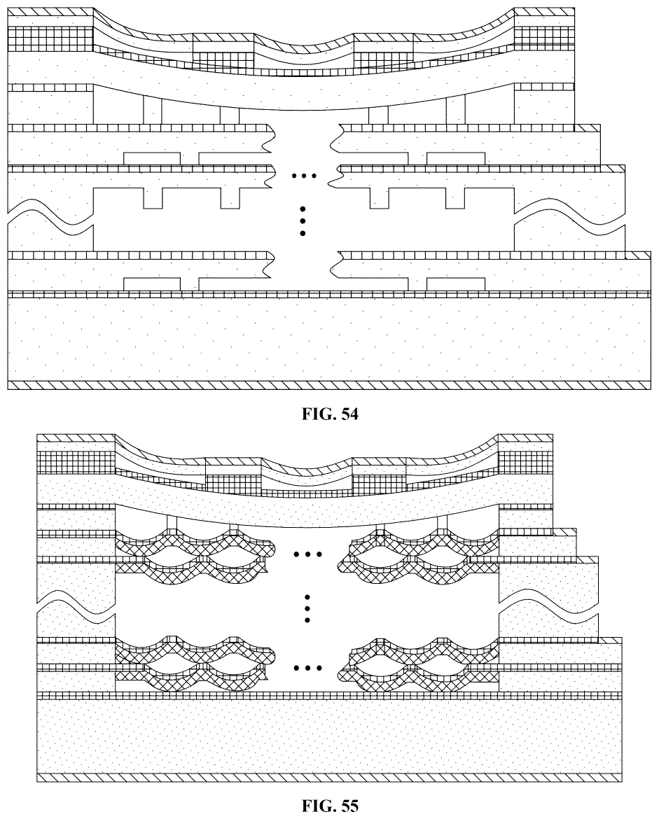

For example, refer to the novel CMUT shown in FIGS. 2A-2B, which includes two chambers (a main chamber and an auxiliary chamber) and two resonant plates (a main resonant plate and a slave resonant plate), where the main chamber is located at the uppermost part, the main resonant plate is disposed at the top of the main chamber, and the slave resonant plate is disposed between the main and auxiliary chambers adjacent to each other up and down and is located at the top of the auxiliary chamber. For another example, refer to the CMUT shown in FIG. 34 to FIG. 55, which includes two types of chambers (a nano-chamber and a micro-chamber) and two types of resonant plates. One of the two types of resonant plates serves as a receiving plate, which is generally located at the top of the nano-chamber, and the other serves as a sending plate, which may also be referred to as the main resonant plate located at the top of the micro-chamber. In some structures, the micro-chamber and the nano-chamber may share a resonant plate, and/or, the adjacent nano-chambers share a resonant plate, etc.

The nano-chamber has a height of ten nanometers to one hundred nanometers in a natural state. For example, the height of the nano-chamber ranges from 10 nm to 10 μm, and particularly preferably from 20 nm to 1 μm.

The micro-chamber has a height of hundred nanometers to nanometers in a natural state. For example, the height of the micro-chamber ranges from 100 nm to 100 μm, and particularly preferably from 200 nm to 10 μm.

The diameter or side length of the micro- or nano-chamber ranges from 100 nm to 10 mm, and particularly preferably from 1 μm to 1 mm.

The resonant plate at the top of the nano-chamber may be a membrane to enhance the stress stiffening effect and prominently increase the bandwidth. The diameter or side length of the membrane ranges from 100 nm to 10 mm, and particularly preferably from 1 μm to 1 mm. the thickness of the membrane ranges from 100 nm to 100 μm, and particularly preferably from 500 nm to 10 μm.

The resonant plate at the top of the micro-chamber may be a plate to reduce the geometric nonlinearity and improve the sending sensitivity. In a same device, the plate is thicker than the membrane, and the plate hardly has a rigidity stiffening effect and satisfies the resonance and/or deformation requirements.

Each of the plurality of chambers is mainly defined by a side wall, a bottom surface, and a top surface. The bottom surface may be the surface of the resonant plate or the upper surface of the substrate, and the top surface is generally the lower surface of a certain resonant plate. A region where the top of the side wall is in contact with the resonant plate may be referred to as an anchor region, and the anchor region and the resonant plate may be connected through bonding and other modes.

To prevent an electrical short-circuit, an insulating layer may be provided on the anchor region, the side wall, and the bottom surface (for example, refer to FIGS. 2A-2B).

The resonant plate at least can vibrate under the action of a driving signal, and has the function of an electrode.

During operation, the plurality of resonant plates resonate at the same frequency or at different frequencies, which can significantly increase the output sound pressure and reduce the dielectric breakdown of the insulating layer.

In some examples, the resonant plate may further include a resonant plate and an electrode layer, where the resonant plate can vibrate but insulate. The electrode layer is in contact with the lower surface and/or the upper surface of the resonant plate (or, an electrode layer is provided on one or two surfaces of the resonant plate), and an electrode can be led from the electrode layer to serve as a lead electrode. For example, refer to FIG. 27, the metal upper electrode in FIG. 27 is the electrode led from the electrode layer of the resonant plate. At this time, the resonant plate and the electrode layer may be made of different materials.

Of course, in some another examples, the resonant plate which can resonate and has an electrode function can be made of a conductive material or a semiconductor material. In this case, a conductive layer may be provided on the upper surface of the resonant plate to serve as a lead electrode, the conductive layer can be obtained, for example, by sputtering a metal layer (in addition to metals, other conductive materials can also be selected) on the surface of the resonant plate, and of course, the conductive layer can be provided on the resonant plate in other modes, which will not be repeated herein. For example, in FIGS. 2A-2B, the metal upper electrode is a lead electrode provided on the upper surface of the main resonant plate, and the metal middle electrode is a lead electrode provided on the upper surface of the slave resonant plate.

In addition, similarly, the substrate itself may be made of a conductive material or a semiconductor material or an insulating material. When the substrate is made of the conductive material or the semiconductor material, a conductive layer may be provided on the lower surface of the substrate to serve as the lead electrode. For example, the metal lower electrode in FIGS. 2A-2B is the lead electrode provided on the lower surface of the substrate. When the substrate is made of the insulating material, a conductive layer may be provided on the upper surface of the substrate, and an electrode is led from the conductive layer to serve as the lead electrode, for example, refer to FIG. 27. The conductive layer can be obtained, for example, by sputtering a metal layer on the upper surface or the lower surface of the substrate, and of course, the conductive layer can be provided on the resonant plate in other modes, which will not be repeated herein.

It can be seen from FIGS. 2A-2B that each chamber corresponds to a pair of lead electrodes, and every two adjacent chambers share a same lead electrode. For example, the main chamber corresponds to the metal upper electrode and the metal middle electrode, the auxiliary chamber corresponds to the metal middle electrode and the metal lower electrode, and the main chamber and the auxiliary chamber share the metal middle electrode.

In the multi-chamber structure, the resonant plate shared by some or all of the upper and lower adjacent chambers can deform (such as the slave resonant plate shown in FIGS. 2A-2B), or at least two chambers have different heights in the natural state (for example, the nano-chamber and the micro-chamber have different heights in the natural state), or both cases are present.

Of course, in addition to the shared resonant plate being capable of deforming, the non-shared resonant plates in all of the other embodiments of the present disclosure can also deform.

Under the action of the deformation of the resonant plates, chambers of different heights may be obtained: for a same chamber, different deformation directions may cause the height of the chamber to increase or decrease compared with the height of the chamber in the natural state. Taking FIGS. 2A-2B as an example, if the main resonant plate protrudes towards the substrate, the height of the main chamber decreases. In addition, the deformation of the resonant plate can cause the height changes of the upper and lower adjacent chambers. Taking FIG. 13 as an example, if the slave resonant plate deforms away from the substrate, the height of the main chamber decreases, and the height of the auxiliary chamber increases; conversely, the height of the main chamber increases, and the height of the auxiliary chamber decreases, as shown in FIG. 16.

In the scenario of receiving an ultrasonic signal, the chamber with a relatively small height in the natural state or after deformation may serve as a receiving chamber, and in the scenario of sending the ultrasonic signal, the chamber with a relatively large height in the natural state or after deformation may serve as a sending chamber. In this way, the multi-chamber structure can adjust the height of the sending and/or receiving chamber or physically separate the sending chamber from the receiving chamber, thereby solving the contradictions in conventional devices that reducing the height of the chamber can improve the receiving sensitivity but limit the resonant amplitude and the output sound pressure, and increasing the height of the chamber can increase the output sound pressure but reduce the receiving sensitivity and increase the driving voltage, such that the output sound pressure is no longer limited by the height of a single chamber.

Therefore, the novel CMUT provided in the embodiments of the present disclosure can improve the receiving sensitivity while increasing the output sound pressure. The height of the sending chamber is maximized and the height of the receiving chamber is minimized as far as possible, and the maximum output sound pressure and the best receiving sensitivity are synchronously obtained as far as possible.

The material of each device part is introduced below.

The material of the resonant plate includes, but is not limited to, the following types:
type I, a semiconductor material, which includes, but is not limited to, single crystal silicon (Si), polycrystalline silicon (Poly), silicon carbide (SiC), diamond, sapphire, etc.;
type II, an insulating material, which includes, but is not limited to, silicon nitride (SixNy), silicon oxide (SiO2), aluminum oxide (Al2O3), aluminum nitride (AlN), etc.;
type III, a metal, which includes, but is not limited to, gold (Au), silver (Ag), aluminum (Al), copper (Cu), tungsten (W), molybdenum (Mo), nickel (Ni), palladium (Pd), platinum (Pt), titanium (Ti), cobalt (Co), chromium (Cr), germanium (Ge), indium (In), tantalum (Ta), iridium (Ir), ruthenium (Ru), etc.; and
type IV, an alloy, which includes, but is not limited to, brass, bronze, tin-brass, phosphor-bronze, aluminum-bronze, silicon-bronze, silicon-red brass, copper-nickel, nickel-silver, nickel-molybdenum, nickel-chromium, nickel-chromium-iron, nickel-chromium-molybdenum, nickel-chromium-cobalt, nickel-titanium, gold-copper, gold-silver, gold-platinum, gold-zinc, gold-palladium, gold-nickel, gold-cadmium, platinum-iridium, platinum-cobalt, platinum-palladium, platinum-ruthenium, platinum-rhodium, platinum-tungsten, platinum-copper, aluminum-copper, aluminum-manganese, aluminum-magnesium, aluminum-magnesium-silicon, aluminum-zinc, aluminum-tin, titanium-copper, titanium-aluminum, titanium-nickel, titanium-molybdenum, titanium-palladium, tungsten-rhenium, iridium-rhenium, etc.

As mentioned above, the resonant plate may include a resonant plate and an electrode layer, and the electrode layer may be provided on the upper surface of the substrate. The electrode layer may serve as a lead electrode, and the material thereof will be introduced in the part of the lead electrode below. The material of the resonant plate includes, but is not limited to, for example, the material of type I or type II mentioned above.

The material of the lead electrode includes, but is not limited to, the following types:
type I, a metal: aluminum (Al), silver (Ag), gold (Au), cobalt (Co), chromium (Cr), copper (Cu), germanium (Ge), indium (In), molybdenum (Mo), nickel (Ni), palladium (Pd), platinum (Pt), silicon (Si), titanium (Ti), tantalum (Ta), tungsten (W), and combinations and alloys thereof, etc.; and
type II, a highly doped semiconductor material, which includes, but is not limited to, a highly doped single crystal silicon (Si), a highly doped polycrystalline silicon (Poly), etc.

The material of the insulating layer involved in the embodiments of the present disclosure includes, but is not limited to, the following types:
type I, a metal nitride, which includes, but is not limited to, silicon nitride (Si3N4), aluminum nitride (AlN), etc.; and
type II, a metal oxide, which includes, but is not limited to, silicon oxide (SiO2), aluminum oxide (Al2O3), hafnium oxide (HfO2), zirconium oxide (ZrO2), tantalum oxide (Ta2O5), etc.

The material of the substrate includes, but is not limited to, the following types:
a semiconductor material: silicon (Si), germanium (Ge), gallium arsenide (GaAs), sapphire, etc.; and
an insulator material: glass, quartz, etc.

The chamber may be, for example, in vacuum or filled with a gas. The type of the filled gas includes, but is not limited to:
type I: air;
type II: an inert gas, which includes, but is not limited to, helium (He), argon (Ar) and other inert gases or combined gases thereof; and
type III: a high-dielectric-constant gas, such as nitrogen (N2), sulfur hexafluoride (SF6), ammonia (NH3), etc.

It should be noted that the relative dielectric constant of air is 1, and the high-dielectric-constant gas herein refers to a gas with a relative dielectric constant greater than 1.

Of course, the gas filled in the chamber may also be a mixture of two or more of the above gases.

The material of forming a 3D conformal surface mentioned in the following embodiments of the present disclosure includes, but is not limited to, the following types:
type I, a semiconductor material, which includes, but is not limited to, single crystal silicon (Si), polycrystalline silicon (Poly), germanium (Ge), gallium arsenide (GaAs), sapphire, diamond, etc.;
type II, an insulating material, which includes, but is not limited to, silicon oxide (SiO2), silicon nitride (Si3N4), aluminum oxide (Al2O3), aluminum nitride (AlN), hafnium oxide (HfO2), zirconium oxide (ZrO2), tantalum oxide (Ta2O5), glass, quartz, etc.; and
type III, a metal material, which includes, but is not limited to, aluminum (Al), silver (Ag), gold (Au), cobalt (Co), chromium (Cr), copper (Cu), germanium (Ge), indium (In), molybdenum (Mo), nickel (Ni), palladium (Pd), platinum (Pt), titanium (Ti), tantalum (Ta), tungsten (W), and combinations and alloys thereof, etc.

The following will further describe the embodiments of the present disclosure in detail based on the common aspects involved above, and the common parts will not be repeated herein.

The following descriptions will be based on two multi-chamber configurations: a main/auxiliary-chamber configuration and a micro/nano-chamber configuration.

### 1, Main/Auxiliary-Chamber Configuration

The plurality of chambers of the novel CMUT have, for example, typical configurations of a main chamber and an auxiliary chamber. There may be at least one main chamber and one or more auxiliary chambers. The main chamber may be above or below the auxiliary chamber (the expression “up and down” herein refers to the position of the substrate or the metal lower electrode as the bottom). In the main/auxiliary-chamber configuration, the resonant plate at the top of the main chamber may be referred to as a main resonant plate; the resonant plate at the tops of the auxiliary chamber may be referred to as a slave resonant plate.

The main chamber and the auxiliary chamber may, for example, respectively have the following uses:

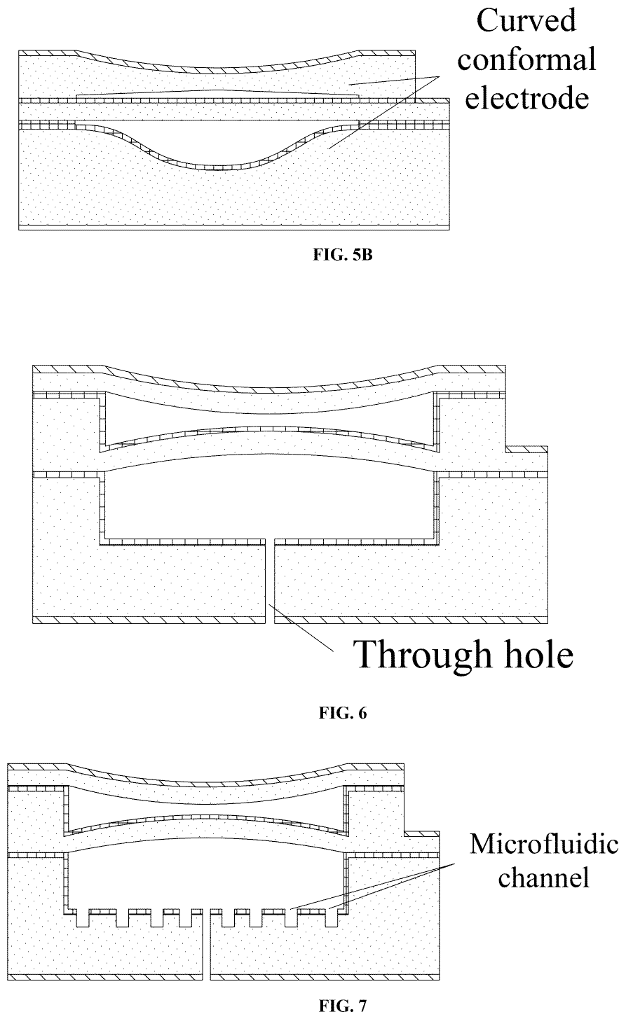

I, The main chamber serves as a sending chamber and a receiving chamber, and the auxiliary chamber is configured to adjust the height of the main chamber. Taking FIGS. 2A-2B as an example, the main chamber in FIGS. 2A-2B can synchronously support sending and receiving of an ultrasonic signal. In this case, refer to FIG. 6 at the same time, at least the slave resonant plate can deform to adjust the height of the main chamber.

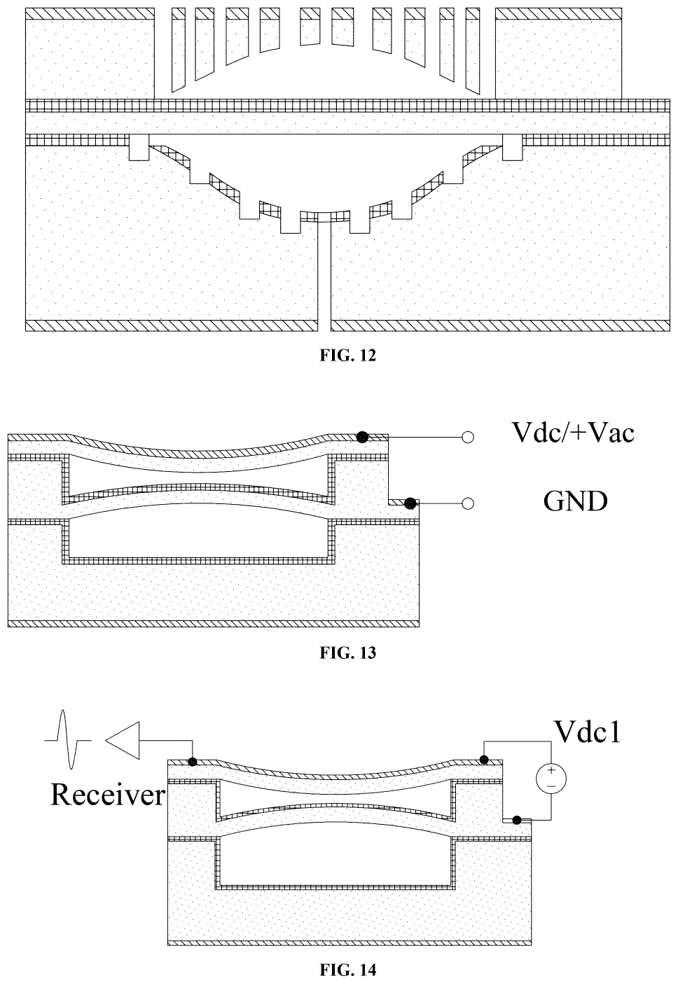

II, The auxiliary chamber supports receiving, or assists the main chamber for sending and receiving, or is configured to adjust the height of the main chamber. For example, in FIG. 6, the main chamber is at the upper part, and the auxiliary chamber is at the lower part. Under the deformation of the slave resonant plate, the heights of the main and auxiliary chambers can be changed, but the auxiliary chamber is not configured to perform receiving and sending. For another example, in FIG. 11 and FIG. 12, the auxiliary chamber is at the upper part, and the main chamber is at the lower part. The main chamber may be configured to send and receive ultrasonic waves, and the auxiliary chamber may be configured to receive the ultrasonic waves.

It should be noted that a certain chamber synchronously supports sending and receiving of ultrasonic waves, but in use, selection may be performed according to requirements. For example, assuming that a certain chamber synchronously supports sending and receiving of ultrasonic waves, when the ultrasonic waves only need to be sent, the chamber operates only in a sending state; similarly, when the ultrasonic waves only need to be received, the chamber operates only in a receiving state. Moreover, in some cases where the ultrasonic waves need to be sent and received, when the ultrasonic waves need to be received, the chamber operates in the receiving state, and when the ultrasonic waves need to be sent, the chamber operates in the sending state. Or, different chambers respectively operate in the receiving state and the sending state, to meet the scenario of requiring both sending and receiving of the ultrasonic waves.

The following uses a dual-chamber, dual-resonant-plate and three-electrode configuration as an example to introduce a novel CMUT structure and various driving (electrode) configurations provided in the embodiments of the present disclosure. However, it should be emphasized that the present disclosure includes, but is not limited to, the typical structure and configuration shown in the drawings.

As shown in FIG. 1, the conventional CMUT mainly consists of a single plate and a single chamber. The chamber is generally in vacuum, and the core performance thereof, such as output sound pressure, sensitivity and driving voltage, is prominently limited by the height of the single chamber. The higher the chamber, the greater the output sound pressure, but will result in lower sensitivity and higher driving voltage, and vice versa.

FIGS. 2A-2B shows an exemplified structure of a novel CMUT structure having dual chambers and dual resonant plates. The novel CMUT structure mainly includes a substrate, a main chamber, an auxiliary chamber, a main resonant plate, and a slave resonant plate. The main chamber serves as a sending chamber and a receiving chamber, and the slave resonant plate can adjust the height of the main chamber. When the main chamber serves as the receiving chamber, the height of the main chamber can be regulated to be very small to prominently improve the sensitivity and reduce the driving voltage; and when the main chamber serves as the sending chamber, the height of the main chamber can be regulated to be large to prominently increase the output sound pressure. The slave resonant plate can be designed with various thicknesses. For example, a membrane can significantly reduce the driving voltage, and a plate can reduce the resonance loss of the slave plate. The membrane and the plate may refer to the descriptions above, which will not be repeated herein.

It should be noted that the substrate and the resonant plate may be made of different materials (for example, in FIG. 2A, the substrate and the resonant plate are represented by different filling line types to indicate different materials). Of course, as shown in FIG. 2B, the substrate and the resonant plate may also be made of the same material, such as silicon. The material of each part has been introduced above, which will not be repeated herein.

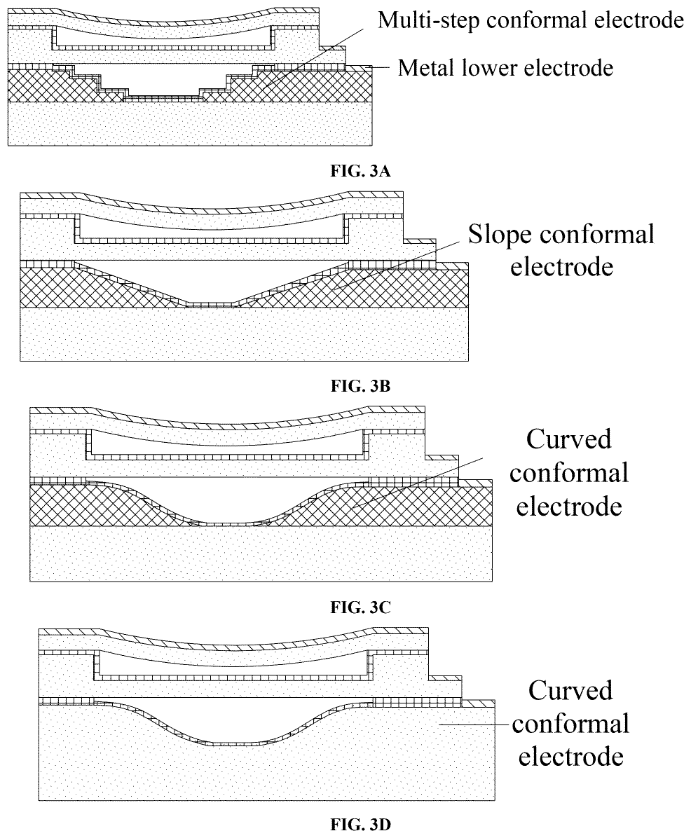

The novel CMUT in all of the other embodiments of the present disclosure may use a 3D conformal electrode design on the substrate and/or the resonant plate to prominently reduce the driving voltage and improve the sensitivity, as shown in FIGS. 3A-3D to FIGS. 5A-5B. The following are introduced respectively:

The novel CMUT shown in FIGS. 3A-3D uses a 3D conformal curved electrode design on the substrate of the auxiliary chamber.

Performing the 3D conformal curved electrode design on the substrate includes, but is not limited to, the following three design modes:

Design mode I: if the substrate is insulated, the part of the upper surface of the substrate located in the chamber can be designed into a conformal surface, and a conductive layer with a uniform thickness is provided on the upper surface of the substrate and serves as a lead electrode. Due to uniform thickness, the lead electrode and the upper surface of the substrate have the same shape. Therefore, the lead electrode is located on the upper surface in the chamber, and a conformal surface is also present. In this design mode, the upper surface of the substrate and the electrode layer thereon both have a conformal surface, and the conductive layer having a 3D conformal surface may be referred to as a conformal electrode.

Design mode II: also in the case where the substrate is insulated, but in this design mode, the upper surface of the substrate is not a conformal surface. For example, the upper surface of the substrate is a plane, a conductive layer may be provided on the upper surface of the substrate to serve as a lead electrode, and the upper surface of the conductive layer has a 3D conformal surface. In design mode II, the conductive layer having a 3D conformal surface may be referred to as a conformal electrode.

Design mode III: if the substrate itself is conductive, the upper surface of the substrate may be wholly or partially designed into a 3D conformal surface. At this time, the whole substrate may be referred to as a conformal electrode.

Design mode IV: no matter the substrate is insulated or not, if an insulating layer needs to be provided on the substrate, the upper surface of the insulating layer is designed into a 3D conformal surface.

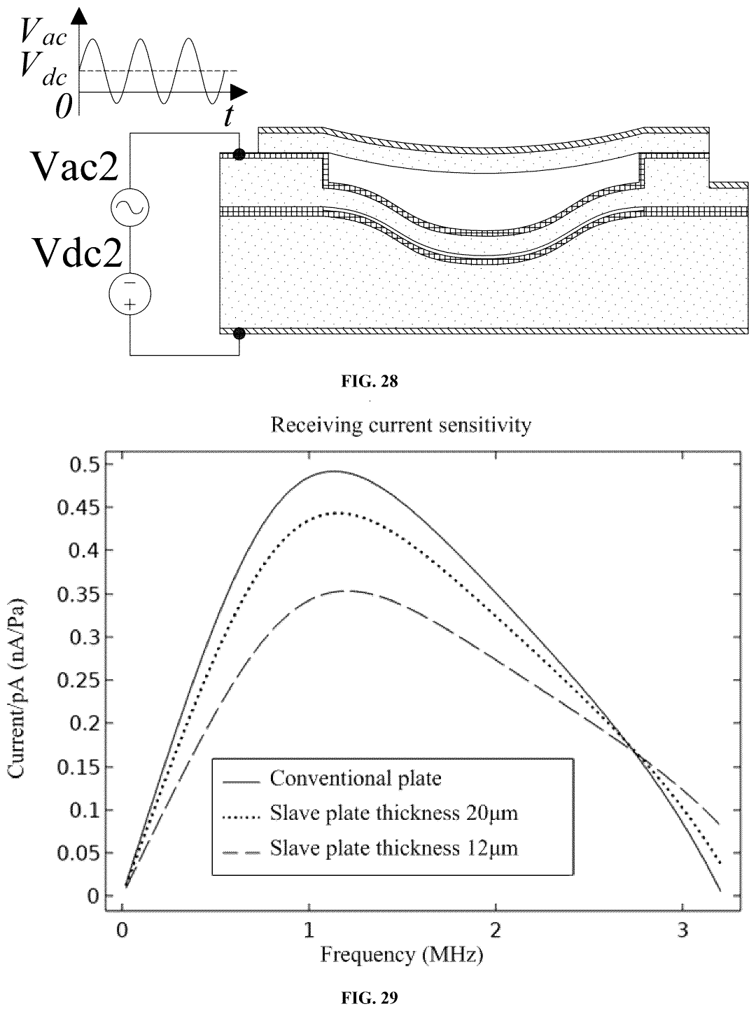

The conformal surface and the deformed resonant plate have the same structural morphology to reduce the equivalent chamber height between electrodes. Taking FIG. 28 as an example, when the slave resonant plate deforms downwards, the 3D conformal surface on the substrate can have the same structural morphology as the deformed slave resonant plate. That is, the distance between the 3D conformal surface and the deformed slave resonant plate is relatively uniform, compared with a conventional planar substrate, the equivalent chamber height between the electrodes can be reduced, thereby significantly improving sensitivity and reducing the driving voltage while not affecting the maximum resonance amplitude and output sound pressure. Compared with the conventional planar electrode, the driving voltage of the auxiliary chamber can be reduced by 80% or above.

It should be noted that although the conformal surface in FIG. 28 deforms toward the substrate, those skilled in the art could configure the conformal surface to protrude away from the substrate according to actual requirements, which will not be repeated herein.

The 3D conformal surface includes, but is not limited to, a 3D curved surface (refer to FIG. 3C and FIG. 3D), multiple steps (refer to FIG. 3A), and a slope (refer to FIG. 3B). Or, a 3D structure may be formed by multiple combinations of the 3D curved surface, multiple steps, and the slope, or a multi-section combination. That is, the 3D conformal surface may be divided into multiple sections, where any section may be a 3D curved surface, multiple steps, or a slope, as long as the overall structure presents an upward or downward protrusion and can have the same structural morphology as the deformed resonant plate.

It should be noted that in FIG. 3A, the material of the substrate is not low-resistance silicon, and an electrode can be directly led from the conformal electrode as the lead electrode, i.e., the metal lower electrode in FIG. 3A.

FIG. 3C and FIG. 3D differ in that: FIG. 3C corresponds to design mode II, and FIG. 3D corresponds to design mode III. Regarding FIG. 3D, if the substrate is made of low-resistance silicon, the lead electrode may be located at the bottom of the substrate.

Specifically, the 3D conformal surface on the upper surface of the substrate can be designed on the basis of a design goal. For example, the design goal is assumed to optimize sending in the normal operating mode. Taking the structure shown in FIGS. 2A-2B as an example, an appropriate driving signal may be added on the slave resonant plate (auxiliary chamber). The driving signal can enable the slave resonant plate to vibrate to the maximum amplitude without being in contact with the planar substrate of the auxiliary chamber, to maximum signal sending in the normal operating mode. At this time, the slave resonant plate downwards protrudes to deform (the shape of the slave resonant plate downwards protruding may refer to FIG. 16). The structural morphology of the conformal surface on the substrate can be designed according to the structural morphology of the slave resonant plate at this time. The upper surface of the conductive layer in design mode II also has a similar design idea.

The collapse mode also has a similar design idea.

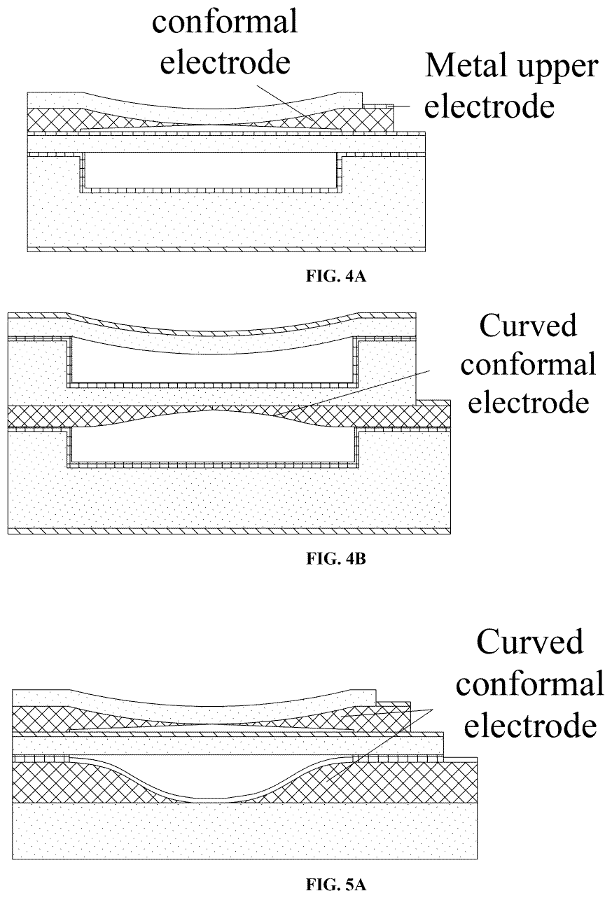

FIGS. 4A-4B and FIGS. 5A-5B are schematic diagrams of applying a 3D conformal electrode design to a resonant plate. In FIGS. 4A-4B, the surface of the main resonant plate facing the main chamber is a 3D conformal surface. The structure of the 3D conformal surface on the main resonant plate may refer to the above descriptions, which will not be repeated herein.

It should be noted that in FIG. 4A, an electrode can be led from the conformal electrode of the main resonant plate to serve as the lead electrode, and the uppermost electrode layer is omitted. In FIG. 4B, the slave resonant plate also uses the same conformal electrode, and an electrode can also be led from the conformal electrode of the slave resonant plate, which will not be repeated herein.

As mentioned above, a resonant plate which can resonate and has an electrode function can be made of a conductive material or a semiconductor material. In this case, refer to FIGS. 5A-5B, the surface of the main resonant plate facing the main chamber may be designed to be a 3D conformal surface. At this time, the whole main resonant plate may also be referred to as a conformal electrode.

Or, as mentioned above, the resonant plate may further include a resonant plate and an electrode layer, and the electrode layer may serve as a lead electrode. In this case, refer to FIG. 4A and FIG. 4B, the surface of the electrode layer facing the main chamber may be designed to be a 3D conformal surface, and at this time, the electrode layer may be referred to as a conformal electrode.

Or, when the main resonant plate is located between two adjacent chambers, in some scenarios, an insulating layer may be laid on the main resonant plate, and the surface of the insulating layer located in the chamber may be designed to be a 3D conformal surface.

It should be noted that although the conformal surface in FIGS. 4A-4B protrudes away from the substrate, those skilled in the art could configure the conformal surface to protrude toward the substrate according to actual requirements, which will not be repeated herein.

The main resonant plate having a 3D conformal curved electrode design can have the same structural morphology as the deformed slave resonant plate, thereby further improving the receiving sensitivity of the main chamber by 70% or above on the basis of the planar electrode.

For example, the 3D conformal surface on the main resonant plate may also be designed on the basis of the design goal. For example, the design goal is assumed to maximize the sensitivity in the normal operating mode. An appropriate driving signal may be added to the main chamber in FIGS. 2A-2B. The driving signal can enable the main resonant plate to vibrate to the maximum amplitude without being in contact with the slave resonant plate. At this time, the main resonant plate downwards protrudes to deform. The shape of the 3D conformal surface on the main resonant plate can be designed according to a mirror image of the structural morphology of the main resonant plate.

The collapse mode where the main resonant plate collapses downwards also has a similar design idea.

In the CMUT shown in FIGS. 5A-5B, the main resonant plate and the substrate of the auxiliary chamber both use a 3D conformal electrode design to obtain optimal sensitivity and the lowest driving voltage. In FIGS. 5A-5B, the surface of the main resonant plate facing the main chamber is a 3D conformal surface (a curved conformal electrode representing the position of the 3D conformal surface in FIGS. 5A-5B), and the surface of the substrate facing the auxiliary chamber is a 3D conformal surface. In addition, it should be noted that the resonant plate and the substrate in FIGS. 5A-5B are, for example, made of the same material, such as silicon. Those skilled in the art can flexibly select the material of each component, which will not be repeated herein.

The 3D conformal surface shown in FIGS. 4A-4B and FIGS. 5A-5B is a curved surface. It can be understood that the 3D conformal surface may also be of other structures. The structure and design of the 3D conformal surface may refer to the above descriptions, which will not be repeated herein.

Also, the slave resonant plate may also use a 3D conformal electrode design. In some structures, the slave resonant plate is connected to the main chamber and the auxiliary chamber, and two surfaces of the slave resonant plate are both set as conformal surfaces. In addition, in other structures, the slave resonant plate is possibly connected to only one chamber, then the surface of the slave resonant plate facing the chamber is set as a conformal surface.

In some scenes, an insulating layer may be laid on the slave resonant plate, and the surface of the insulating layer located in the chamber may be designed as a 3D conformal surface.

The conformal surface of the slave resonant plate can be designed according to its own maximum deformation, which will not be repeated herein.

In addition to the exemplified structure shown in FIGS. 3A-3D to FIGS. 5A-5B, the main resonant plate and the slave resonant plate may also use a 3D conformal electrode design, or, the slave resonant plate and the substrate both use 3D conformal electrodes, or, the main resonant plate, the slave resonant plate, and the substrate all use 3D conformal electrodes.

The novel CMUT in all the other embodiments of the present disclosure may adjust the dynamic characteristics and the bandwidth by introducing gas squeeze-film damping.

Specifically, the gas squeeze-film damping may be introduced by a gas squeeze-film damping regulation microstructure in the novel CMUT

The gas squeeze-film damping regulation microstructure may include any one or any combination of a through hole, a hollow, and a microfluidic channel. The following are introduced respectively.

It should be noted that since the materials used for the various components of the novel CMUT have been described above, for the sake of convenience, in the accompanying drawings corresponding to the subsequent embodiments, the resonant plate and the substrate are made of the same material. Those skilled in the art can understand that different components may also be made of different materials.

A through hole may be formed in the substrate in all the other embodiments of the present disclosure to introduce a gas into the auxiliary chamber, as shown in FIG. 6. The size of the through hole may be in the micrometer level or below. For example, the diameter of the through hole ranges from 1 μm to 500 μm, and particularly preferably from 10 μm to 50 μm.

Since the height of the chamber is usually as low as the micrometer to nanometer level, the gas squeeze-film effect will dominate the dynamic characteristics (response frequency, response time, etc.) of the slave resonant plate. The gas squeeze-film effect includes a stiffening effect and a damping effect, where the stiffening effect prominently increases the resonance frequency of the resonant plate, and the damping effect prominently affects the dynamic response (response frequency and response time) of the system, and can be configured to adjust the bandwidth.

Those skilled in the art can flexibly design the size, quantity and distribution of the through hole according to actual requirements, which will not be repeated herein.

At least one resonant plate in all the other embodiments of the present disclosure may be provided with a through hole, or is of a hollowed structure; and a gas squeeze-film effect may also be introduced.

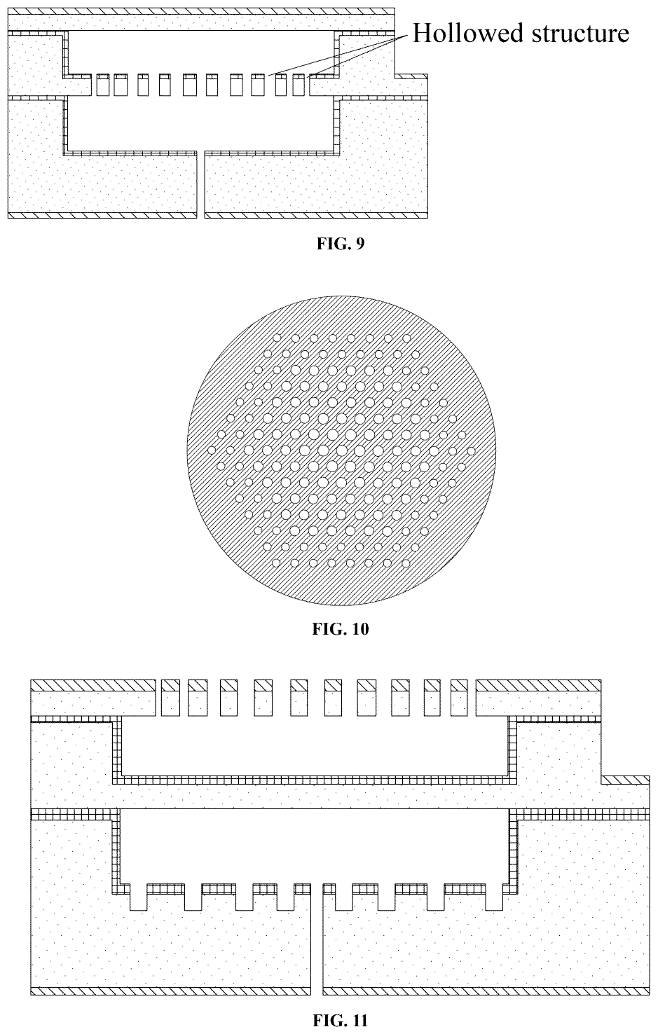

For example, the gas squeeze-film effect may be introduced in the resonant plate between the adjacent chambers by venting a through hole and/or hollowing (as shown in FIG. 9) the resonant plate, to adjust the dynamic characteristics of the uppermost resonant plate and prominently increase the bandwidth. The typical hollowed structure is as shown in FIG. 10.

The size of the through hole formed in the resonant plate may be in the micrometer level or below. For example, the diameter of the through hole ranges from 1 μm to 500 μm, and particularly preferably from 10 μm to 50 μm. Those skilled in the art can flexibly design the size, quantity and distribution of the through hole according to actual requirements, which will not be repeated herein.

For another example, for the CMUT using a gas as a propagation medium, as shown in FIG. 11, the uppermost resonant plate may be selected to hollow as the slave resonant plate, and the non-hollowed resonant plate (the resonant plate being located between two adjacent chambers) is configured to send and receive an ultrasonic signal and serves as the main resonant plate, to prominently improve the sensitivity and reduce the driving voltage.

In FIG. 11, the upper chamber is the auxiliary chamber, and the lower chamber is the main chamber. Taking reception as an example, an ultrasonic signal directly hits a non-hollowed main resonant plate through a hollowed slave resonant plate, and the main resonant plate receives the ultrasonic signal. At this time, since the substrate is also provided with a through hole, the main and auxiliary chambers can simultaneously receive the ultrasonic signal through the slave resonant plate, thereby amplifying a current generated by the reception. When sending, ultrasonic waves are mainly sent by the main resonant plate and the main chamber.

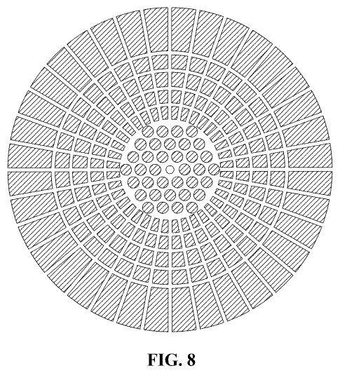

In other embodiments of the present disclosure, as shown in FIG. 7, the surface of the substrate in all the above embodiments facing the resonant plate may employ microfluidic channels (i.e., microfluidic channels being provided on the surface), to adjust the dynamic characteristics of the resonant plate, prominently increase the bandwidth, and remarkably reduce the driving voltage of the auxiliary chamber. The mentioned microfluidic channels design has a variety of structures and layouts, such as a micro-pillar array, fan-shaped channels, and a hybrid microfluidic structure of the micro-pillar array and the fan-shaped channels. The typical structure is as shown in FIG. 8. FIG. 8 includes protrusions of different shapes (a columnar protrusion and a fan-shaped protrusion), and microfluidic channels are between the adjacent protrusions. By adjusting the height/depth of the microfluidic channels, the bandwidth can be adjusted.

The through hole, the hollow, and the microfluidic channels mentioned above can be used in any combination, for example, in FIG. 11, which will not be repeated herein.

Furthermore, the through hole, the hollow, and the microfluidic channels mentioned above are also applicable to the novel CMUT having a 3D conformal electrode, as shown in FIG. 12, which will not be repeated herein.

The following still takes the CMUT with dual chambers and dual resonant plates as an example to introduce a plurality of electrode configuration modes under the main/auxiliary chamber configuration.

The existing CMUT having a single chamber is provided with a pair of lead electrodes, whereas the CMUT having dual chambers is provided with more lead electrodes, thereby having richer multi-electrode configuration modes.

The overall idea of the electrode configuration of the CMUT in each embodiment of the present disclosure is: when the novel CMUT is configured to receive a signal, a pair of lead electrodes corresponding to the receiving chamber (a chamber configured to receive a signal) is respectively connected to a positive electrode and a negative electrode of a direct-current bias voltage (one of the pair of lead electrodes being connected to the positive electrode, and the other one being connected to the negative electrode). When the novel CMUT is configured to send a signal, a pair of lead electrodes corresponding to the sending chamber (a chamber configured to send a signal) is at least respectively connected to a positive electrode and a negative electrode of a driving signal. The driving signal may, for example, include, but is not limited to, a signal obtained after an alternating-current driving signal is subjected to direct-current bias, or an alternating-current driving signal, or a continuous pulse signal, or a signal obtained after the continuous pulse signal is subjected to direct-current bias.

That is, in the embodiments of the present disclosure, the driving signal is not limited to a conventional alternating-current driving signal such as sine waves, may also be a continuous pulse sequence, or a continuous pulse sequence with a direct-current bias, as shown in FIG. 20. Compared with the conventional sine wave excitation, the continuous pulse sequence without direct-current bias can increase the output sound pressure by nearly 20%.

Multiple electrodes increase the degree of freedom in the optimization of the new CMUT. Some electrode configurations can achieve independence of sending and receiving functions, and some electrode configurations can achieve switch-free switching between the sending and receiving modes, thereby eliminating significant heating caused by a conventional electronic mode handover switch.

Some electrode configuration modes are described below.

Conventional dual-lead-electrode configuration:

For example, refer to FIG. 13, the main resonant plate can receive the ultrasonic waves by applying a direct-current bias voltage (Vdc) to the main resonant plate, and can send the ultrasonic waves by applying a driving signal to the main resonant plate. “Vdc/+Vac” in FIG. 13 indicates that Vdc is applied, or Vac is applied, or Vdc+Vac is applied simultaneously.

As mentioned above, the driving signal may, for example, include, but is not limited to, a signal obtained after the alternating-current driving signal is subjected to direct-current bias, or an alternating-current driving signal, or a continuous pulse signal, or a signal obtained after the continuous pulse signal is subjected to direct-current bias. Vac in FIG. 13 represents the alternating-current driving signal or the continuous pulse signal. Vdc+Vac represents a signal obtained after the alternating-current driving signal is subjected to direct-current bias, or a signal obtained after the continuous pulse signal is subjected to direct-current bias. It should be noted that “+” in “Vdc+Vac” represents superimposition and is not configured to represents “positive” in “positive and negative”.

In this example, the main chamber serves as a sending chamber and a receiving chamber. When the main chamber serves as the receiving chamber, the height of the main chamber can be regulated to be very small through the deformation of the slave resonant plate, to prominently improve the sensitivity and reduce the driving voltage, as shown in FIG. 14. The slave resonant plate can be designed with various thicknesses. For example, a membrane can significantly reduce the driving voltage, and a plate can reduce the energy consumption of the slave plate. Reference may be made to the above descriptions, which will not be repeated herein.

Parallel configuration of three lead electrodes:

The parallel configuration can implement parallel connection of two chambers, such that the two chambers can be independently driven, respectively. Any chamber can be connected to different signals when used for different purposes. For example, when a certain chamber is configured to receive a signal, a pair of lead electrodes of the chamber can be connected to the direct-current bias voltage; and when the chamber is configured to send a signal, the pair of lead electrodes is connected to the driving signal. The related introductions of the driving signal may refer to the above descriptions, which will not be repeated herein.

Parallel configuration of three lead electrodes:

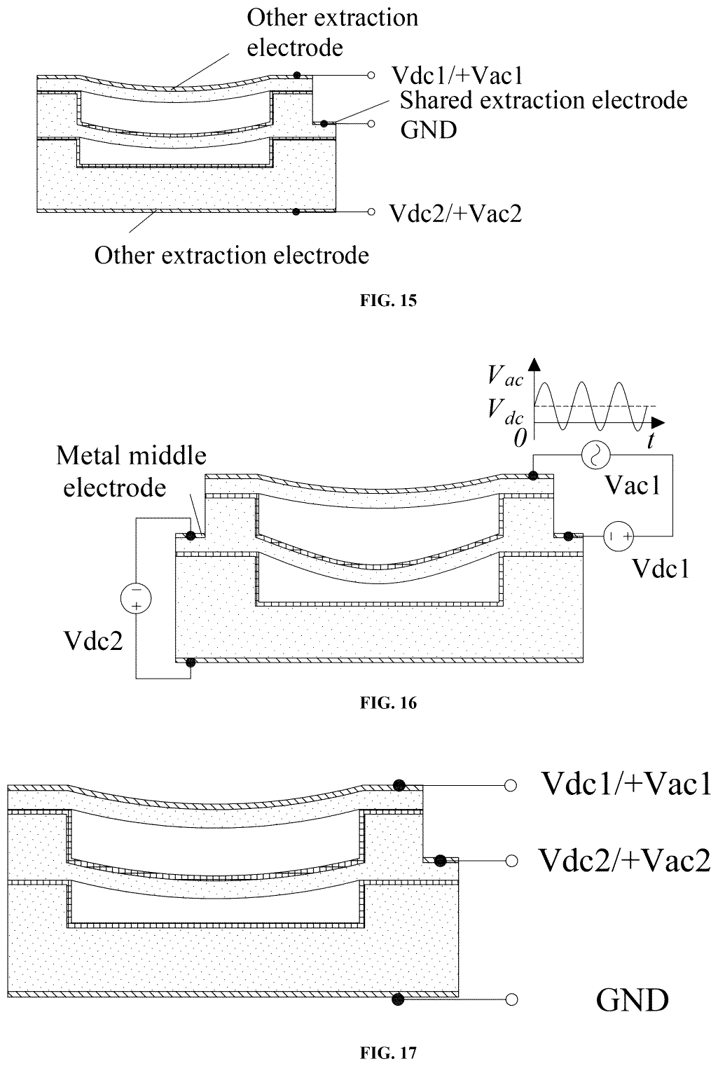

Among three lead electrodes, one lead electrode is shared by the chambers, for example, a lead electrode located in the middle in FIG. 15 is shared by dual chambers.

In one example, the following configuration can be performed on the three lead electrodes:
the lead electrode shared by a plurality of chambers is connected to the ground (GND), and GND serves as a common negative electrode. The other lead electrodes can be connected to a positive electrode of the signal received by the chamber.

The received signal may specifically be the direct-current bias voltage or the driving signal. Specifically, refer to the lead electrode configuration shown in FIG. 15, the independent driving of the main and auxiliary chambers can be implemented. Since there are multiple chambers, for the convenience of expression, the signals connected to different chambers are further described as a first direct-current bias voltage, a second direct-current bias voltage, a first driving signal, a second driving signal, a first alternating-current driving signal, a second alternating-current driving signal, a first continuous pulse signal, a second continuous pulse signal, etc.

The lead electrode configuration shown in FIG. 15 can have a variety of subdivided configuration forms according to different applied signals. For example:

Configuration I: the second direct-current bias voltage Vdc2 is applied to the auxiliary chamber, such that the slave resonant plate has a certain displacement bias (deformation), thereby increasing the height of the main chamber to prominently increase the output sound pressure, and the first driving signal is applied to the main chamber, as shown in FIG. 16.

Configuration II: the second driving signal (the second alternating-current driving signal or the second continuous pulse signal Vac2 or Vac2 and Vdc2) is applied to the auxiliary chamber alone, such that the slave resonant plate vibrates.

Configuration III: the first driving signal (the first driving signal including the first alternating-current driving signal or the first continuous pulse signal Vac1 or Vac1 and the first direct-current bias voltage Vdc1) is applied to the main chamber alone, such that the main resonant plate vibrates to send ultrasonic waves. The alternating-current signal may also be referred to as an alternating-current driving signal.

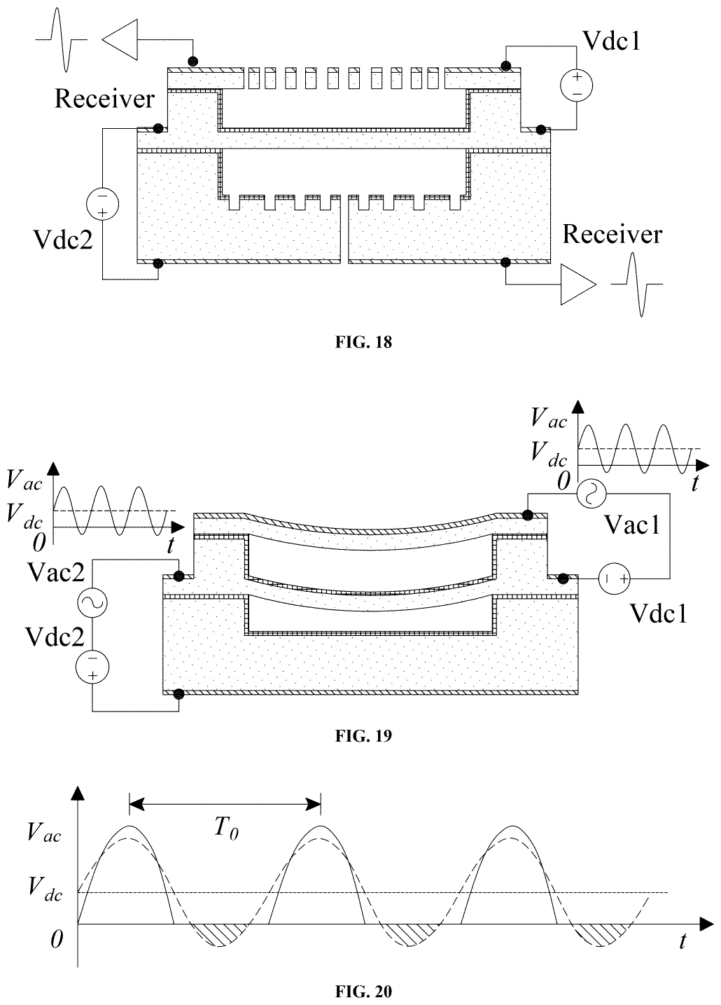

Configuration IV: Vdc1 is applied to the main chamber alone, such that the slave resonant plate has a certain displacement bias (deformation), thereby reducing the height of the main chamber, and the main resonant plate receives the ultrasonic waves.
Configuration V: the main and auxiliary chambers are both configured to receive signals, and Vdc1 and Vdc2 are respectively applied to the main and auxiliary chambers.
Configuration VI: the main and auxiliary chambers are both configured to send signals, and a first driving signal and a second driving signal are respectively applied to the main and auxiliary chambers.
Configuration VII: Vdc1 is applied to the main chamber, and the second driving signal is applied to the auxiliary chamber.
Configuration V can be optimized through multiple lead electrodes such that the main and auxiliary chambers both receive ultrasonic waves, thereby achieving multiple amplification of a received current signal, as shown in FIG. 18.

In FIG. 18, the main resonant plate is provided with a through hole or is of a hollowed structure, and the substrate is also provided with a through hole. The ultrasonic waves hit the resonant plate shared by the two chambers through the main resonant plate, and the direct-current bias voltage is applied to both the main chamber and the auxiliary chamber such that both the main chamber and the auxiliary chamber receive the ultrasonic waves and generate current signals, respectively. The main chamber and the auxiliary chamber generate two current signals in total, which are led through the lead electrodes.

In addition, since the main chamber and the auxiliary chamber generate two current signals in total, and the two current signals can be subsequently received at the positive and negative electrodes of an amplifier circuit, the differential output of the received signal can be implemented, and the signal-to-noise ratio of the received signal is prominently increased.

Configuration VI can implement the same-frequency or different-frequency dual resonance of the main and slave resonant plates by applying the driving signals to the main and slave resonant plates at the same time to significantly increase the resonance amplitude and output sound pressure, as shown in FIG. 19. It should be noted that the driving signals applied to the main and auxiliary chambers in FIG. 19 include a direct-current bias voltage, to cause the main and slave resonant plates to deform in the same direction.

The natural frequencies of the main and slave resonant plates can be designed to be the same or different.

Series configuration of three lead electrodes:

In one example, the following configuration can be performed:

Among a plurality of lead electrodes, the lead electrode located at the bottommost part or the topmost part is connected to GND, and as a common negative electrode, the other lead electrodes are connected to the positive electrodes of signals received by the corresponding chambers.

Specifically, refer to the multi-lead-electrode series configuration of three lead electrodes shown in FIG. 17, which can implement combined driving of the main and auxiliary chambers.

In FIG. 17, the lead electrode at the substrate of the auxiliary chamber is grounded, when the auxiliary chamber receives a signal, the lead electrode shared by the auxiliary chamber and the main chamber can be connected to the positive electrode of the second direct-current bias voltage (Vdc2), and when the auxiliary chamber sends a signal, the shared lead electrode can be connected to the positive electrode of the second driving signal (Vac2, or Vac2 and Vdc2).

Regarding the lead electrode used by the main chamber alone, when the main chamber receives a signal, the lead electrode can be connected to the positive electrode of the first direct-current bias voltage (Vdc1), and when the main chamber sends a signal, the lead electrode can be connected to the positive electrode of the first driving signal (Vac1, or Vac1 and Vdc1).

Similarly, the lead electrode configuration shown in FIG. 17 can have a variety of subdivided configuration forms according to different applied signals. Refer to the above descriptions about configuration I and configurations V to VII, which will not be repeated herein.

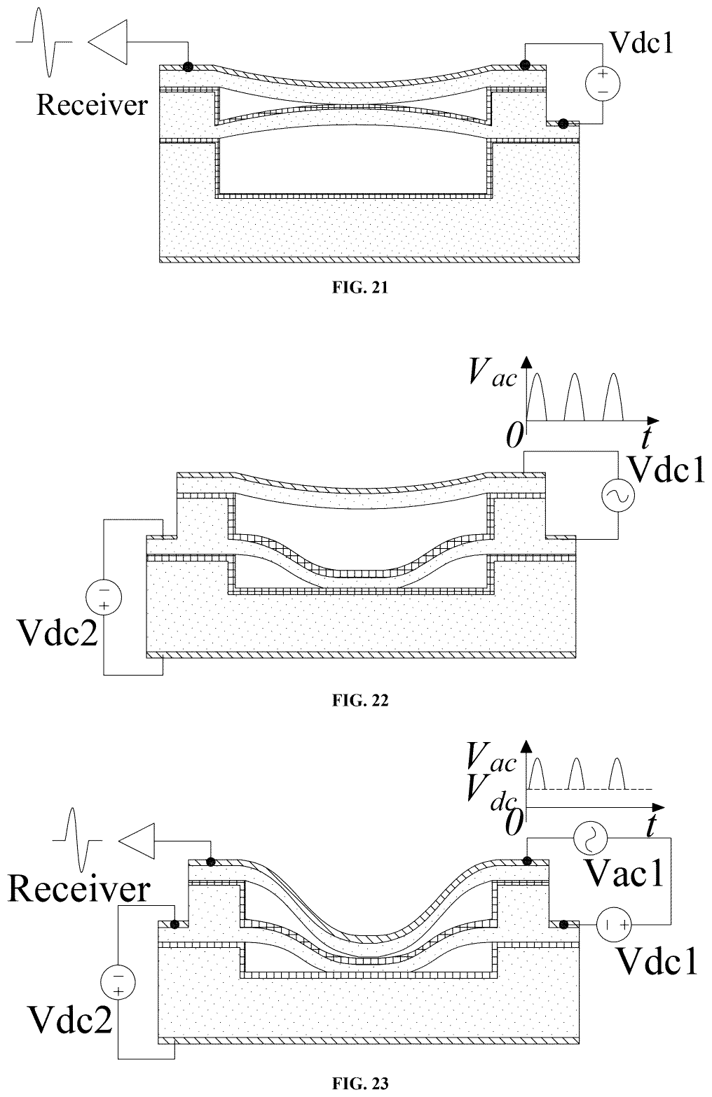

The novel CMUT with the above main-auxiliary chamber configuration can also operate in a collapse mode, as shown in FIG. 21 to FIG. 25 (the receiver in the drawings representing a receiving amplifier).

Here is a brief introduction to the difference between the normal mode and the collapse mode: each chamber has a critical voltage, also called a pull-in voltage (a collapse voltage, or a pull-down voltage). If the direct-current bias voltage applied to the chamber is greater than the pull-in voltage, the resonant plate connected to the chamber collapses (at this time, the resonant plate at the top of the chamber being in contact with the bottom of the chamber), which corresponds to the collapse mode. If the direct-current bias voltage is less than the pull-in voltage, this case corresponds to the normal operating mode (in the normal operating mode, the direct-current bias voltage being generally a percentage of the pull-in voltage, such as 80% of the pull-in voltage).

If the direct-current bias voltage applied to the chamber in the collapse state may also be referred to as a collapse driving direct-current voltage. If as a sending chamber, the driving signal mentioned above is also applied to the collapse driving direct-current voltage.

For example, as shown in FIG. 21, when the main chamber serves as a receiving chamber, a pair of lead electrodes of the main chamber is connected to the collapse driving direct-current voltage, and the slave resonant plate collapses towards the main resonant plate. In this way, the electromechanical conversion coefficient can be prominently increased, the sensitivity can be increased by almost three times, or even more than three times compared with the normal mode. The specific lead electrode configuration may refer to FIG. 14.

For another example, as shown in FIG. 22, a pair of lead electrodes of the auxiliary chamber is connected to the collapse driving direct-current voltage (i.e., the direct-current bias voltage applied to the auxiliary chamber exceeding the pull-in voltage of the auxiliary chamber), the slave resonant plate collapses towards the substrate of the auxiliary chamber, and the height of the main chamber is increased to the height sum of the main and auxiliary chambers. Therefore, the vibration amplitude of the main resonant plate is prominently increased, and the output sound pressure is prominently increased. The electrode configuration of the main and auxiliary chambers may be, for example, the parallel or series configuration of the lead electrodes. Refer to FIG. 15 or FIG. 17 for details.

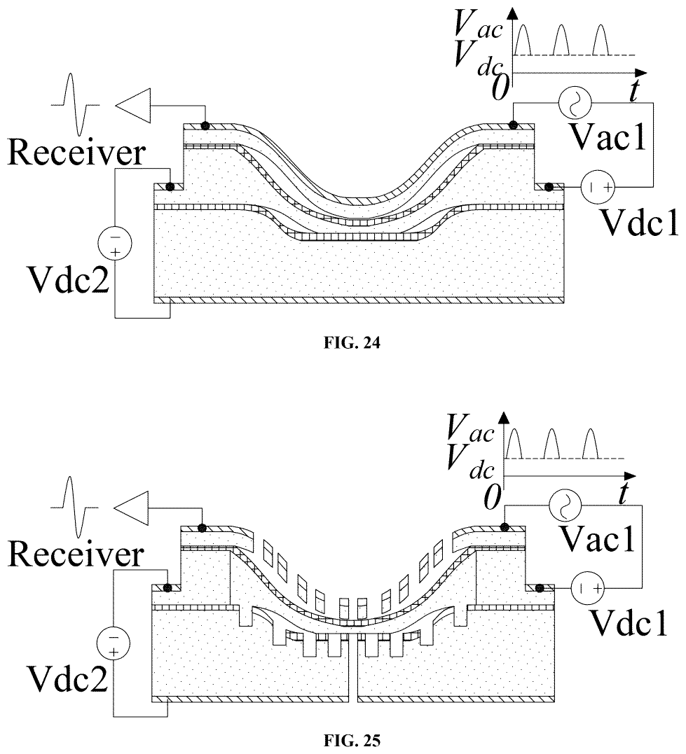

In addition, a pair of lead electrodes of the main or auxiliary chamber can be respectively connected to respective collapse driving direct-current voltages, such that the main and slave resonant plates collapse towards the substrate of the auxiliary chamber, and the main and slave resonant plates both operate in the collapse mode, as shown in FIG. 23. The 3D conformal electrode design is also applicable to a multi-resonant-plate and multi-chamber CMUT in the collapse mode, as shown in FIG. 24, which will further improve the sensitivity and reduce the driving voltage compared to the conventional planar electrode. The electrode configuration of the main and auxiliary chambers in FIG. 23 and FIG. 24 may be, for example, the parallel or series configuration of the lead electrodes. Refer to FIG. 15 or FIG. 17 for details.

The introduction of the gas squeeze-film damping effect is also applicable to the multi-resonant-plate and multi-chamber CMUT in the collapse mode. FIG. 25 shows a CMUT which uses the 3D conformal electrode design and introduces the gas squeeze-film damping effect, and the main and slave resonant plates thereof both operate in the collapse mode. The electrode configuration of the main and auxiliary chambers may be, for example, the parallel or series configuration of the lead electrodes. Refer to FIG. 15 or FIG. 17 for details.

The following is an introduction to the performance of a novel CMUT, which has dual plates and dual chambers and operates in a normal mode, with specific parameters:

The operating frequency of the CMUT is set to 1.0 MHz and the radius is 220 μm. The heights of the main and auxiliary chambers are both 0.4 μm in the natural state, and a 20 μm thick main resonant plate is selected.

When the CMUT is configured to receive an ultrasonic signal, the driving voltage thereof is a direct-current bias voltage (DC), which is usually a percentage voltage, i.e., a percentage of the pull-in voltage. When the CMUT is configured to send an ultrasonic signal, the driving voltage is a sum of the direct-current bias voltage (DC) and an alternating-current voltage (AC).

The conventional single-chamber CMUT has a pull-in voltage of 103.3 V, an operating frequency of 1.0 MHz, and a radius of 220 μm. The height of the chamber in the natural state is 0.4 μm, and the thickness of the resonant plate is 20 μm.

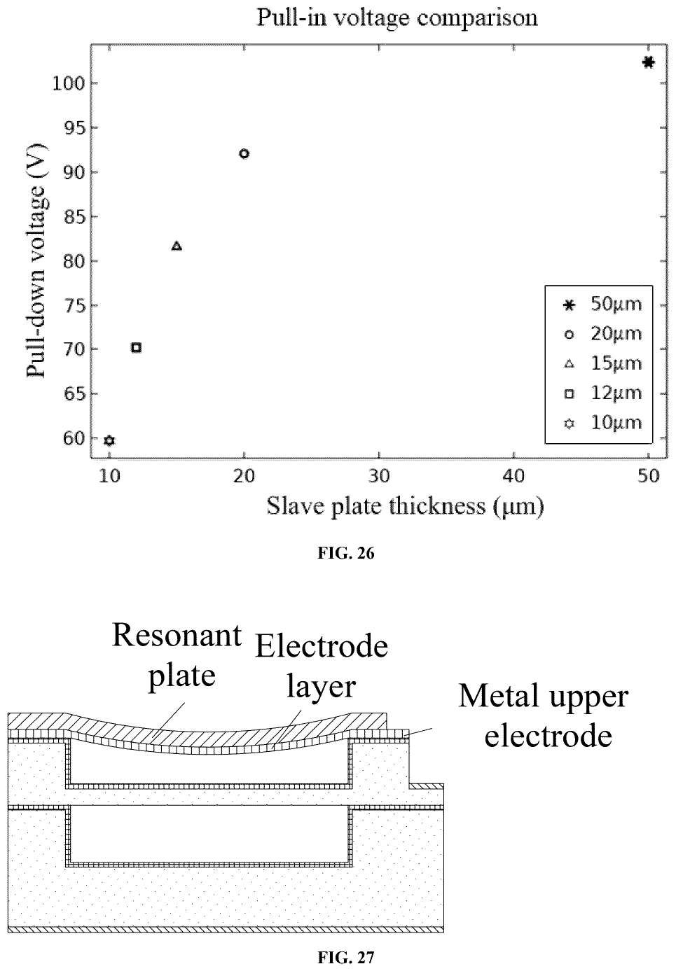

Upon comparison, the pull-in voltage of the novel CMUT decreases significantly as the thickness of the slave resonant plate becomes thinner. For example, when the thickness of the slave resonant plate is 10 μm, the pull-in voltage is reduced by more than 43% compared with the conventional CMUT, as shown in FIG. 26.

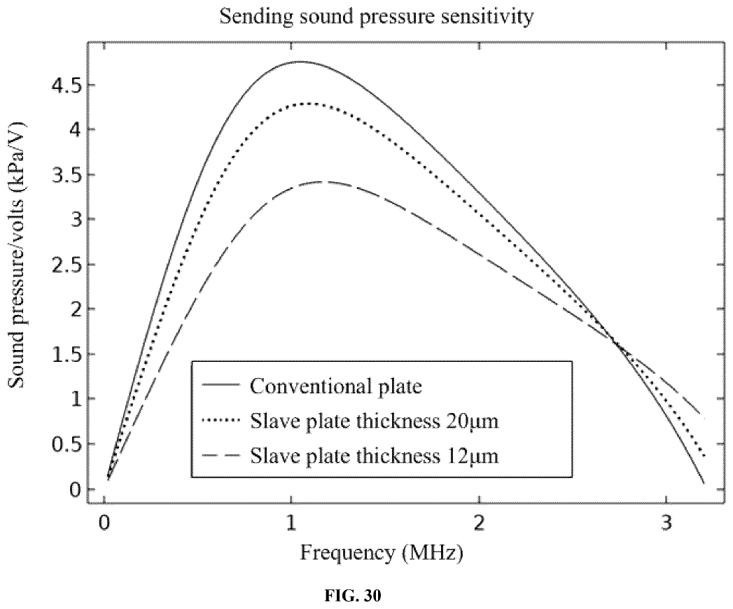

After the gas squeeze-film effect is introduced into the auxiliary chamber through a tiny through hole, the receiving sensitivity and sending sensitivity thereof are shown in FIG. 29 and FIG. 30.

It should be noted that although the peak value of the novel CMUT at the 1 M frequency in FIG. 29 and FIG. 30 is less than that of the conventional CMUT, since the pull-in voltage thereof is also significantly reduced, if the pull-in voltage is converted to the same pull-in voltage as the CMUT, the sending sensitivity and the receiving current sensitivity thereof are higher than those of the conventional CMUT. For example, compared to the conventional CMUT, the novel CMUT with a 12 μm thick slave resonant plate achieves a maximum sensitivity of 71.8% with 67.9% of the driving voltage. Compared with the conventional CMUT, the receiving and sending sensitivities are significantly improved with respect to the reduction of the pull-in voltage.

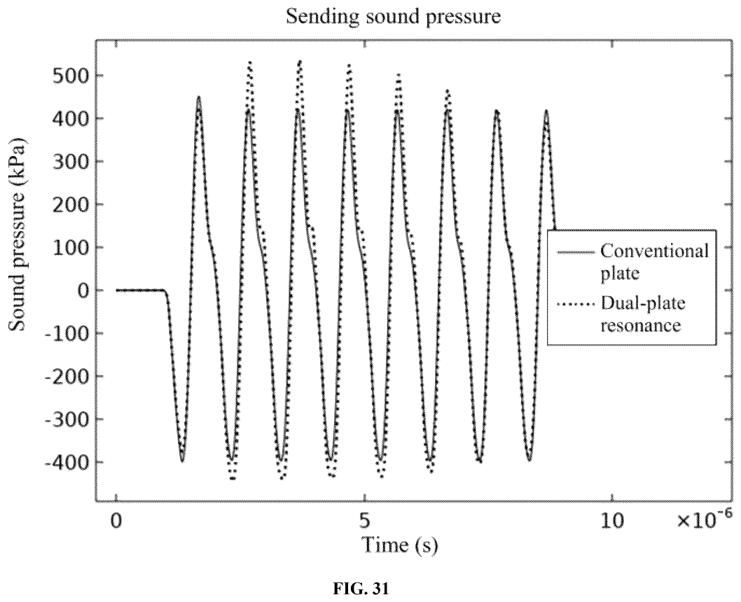

FIG. 31 shows the maximum output sound pressure generated by the co-frequency cooperative resonance of the dual plates, which is increased by more than 20% compared with the conventional CMUT.

As mentioned above, the novel CMUT can operate in the collapse mode. We show a CMUT operating in the collapse mode (FIG. 21) with an operating frequency of 1.0 MHz, and the heights of the main and auxiliary chambers in the natural state are respectively 0.2 μm, to minimize the driving voltage and prominently improve the receiving sensitivity. In addition, the novel CMUT has a radius of 220 μm, a main resonant plate having a thickness of 20 μm, and a slave resonant plate having a thickness of 15 μm.

When the main chamber serves as a sending chamber, the height of the main chamber becomes 0.4 μm after the slave resonant plate (also referred to as a slave plate) collapses towards the substrate. At this time, the pull-in voltage is reduced to 18.95 V, which is only 18.3% of the pull-in voltage (103.3 V) of the conventional CMUT.

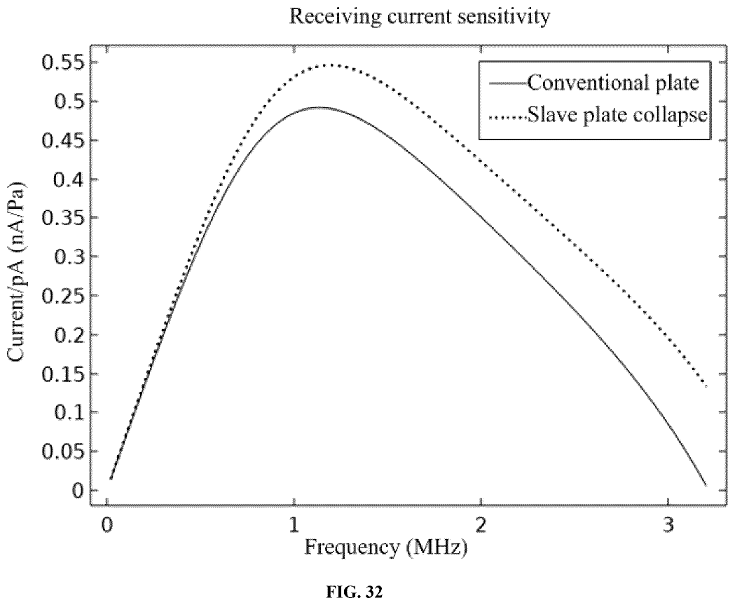

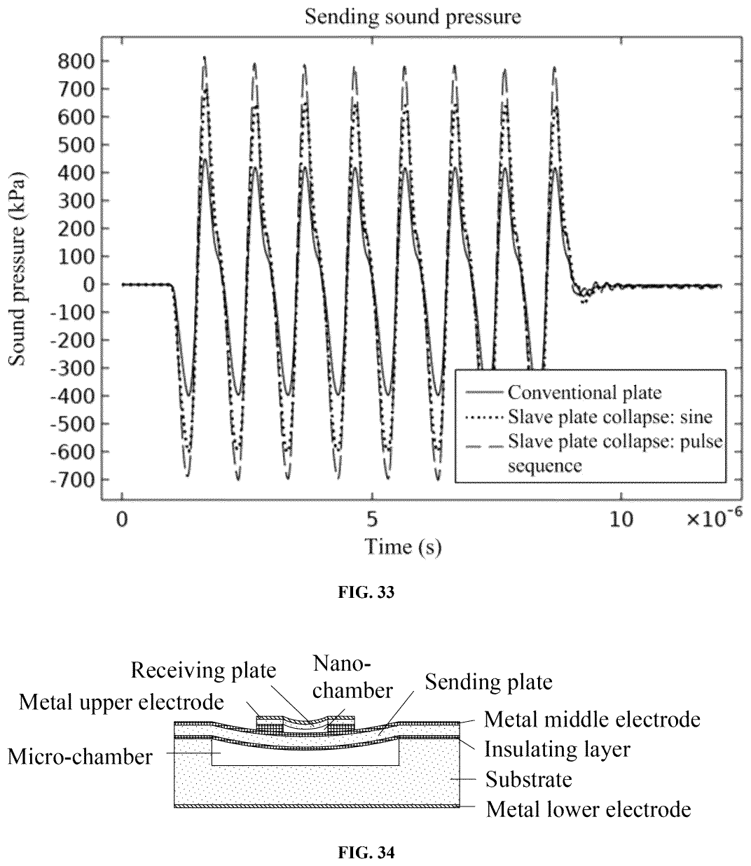

FIG. 32 shows the receiving sensitivity of the novel CMUT in the collapse mode, which is more than 111% of that of the conventional CMUT, but the driving voltage is only 18.3% of that of the conventional CMUT. FIG. 33 shows the maximum output sound pressure, where a more than 151% increase is achieved by conventional sine wave driving, and a more than 183% increase is achieved by continuous pulse sequence driving.

The receiving sensitivity and the maximum output sound pressure are the conflicting core performance indicators of the existing single-plate single-chamber CMUT design. Compared with the single-plate single-chamber CMUT, the significant advantage of the multi-chamber, multi-resonant-plate and multi-lead-electrode configuration proposed in the embodiments of the present disclosure is to obtain the largest possible output sound pressure with the smallest possible driving voltage, while significantly improving the receiving sensitivity. Compared with the conventional CMUT, the driving voltage is reduced by at least 4 times, while the output sound pressure and the sensitivity are improved by at least 200%.

In view of the above, the CMUT with the main/auxiliary chamber configuration at least has the following advantages:
1) The output sound pressure is prominently increased, and high receiving sensitivity and low driving voltage are maintained;
2) The multi-lead-electrode configuration makes the sending and receiving functions independent, and multi-chamber implements physical height adjustment of the sending and receiving chambers; the optimal output sound pressure and receiving sensitivity are obtained at a low driving voltage; the multi-chamber and multi-lead-electrode configuration can implement switch-free switching between the sending and receiving modes, thereby eliminating significant heating caused by a conventional electronic mode switching, and can implement differential output, thereby prominently increasing the signal-to-noise ratio (SNR) of the received signal;
3) The 3D conformal electrode design can be introduced into the multi-chamber and multi-resonant-plate structure, thereby further improving the sensitivity and reducing the driving voltage; the gas squeeze-film damping design can be introduced into the multi-chamber to tune the bandwidth and restrain harmonic waves; and novel continuous pulse sequence driving signals can be applied to replace conventional bias sine signals, thereby further increasing the output sound pressure.

### 2. Micro-Nano Stacked Chamber Configuration

In this configuration, the multi-chamber structure mentioned above includes a micro-chamber, a nano-chamber, and a resonant plate. Generally, the micro-chamber serves as a sending chamber, and the nano-chamber serves as a receiving chamber. There are two types of resonant plates, one serves as a receiving plate, which is generally located at the top of the nano-chamber, and the other serves as a sending plate, which may also be referred to as a main resonant plate generally located between the micro-chamber and the nano-chamber.

In some embodiments, there may be one nano-chamber.

The following uses a stacked-chamber and three-lead-electrode configuration as an example to introduce. It should be noted that the technical solution of the present disclosure includes, but is not limited to, the typical structure and configuration shown in the drawings.

FIG. 34 shows an exemplified structure of a novel CMUT having a micro-nano stacked chamber: the micro-chamber serves as a sending chamber, which has a large height to prominently increase the output sound pressure; and the nano-chamber is disposed at the upper part of the micro-chamber, which serves as a receiving chamber to prominently improve the receiving sensitivity and reduce the driving voltage. Therefore, the structure can implement physical separation of the sending chamber and the receiving chamber.

It should be noted that the lead electrodes (the metal upper electrode, the metal middle electrode, and the metal lower electrode) shown in FIG. 34 are located on the upper surface of the resonant plate and the lower surface of the substrate. However, in some structures, the lead electrodes may also be located on the lower surface of the resonant plate, the upper surface of the substrate, etc., which will not be repeated herein.

In addition, there may be two or more nano-chambers, and there are many possible relationships between two or more nano-chambers, such as side-by-side, cascade, and side-by-side and cascade hybrid. The relationships are introduced respectively below:

I. Side-by-side

The nano-chambers arranged side by side may be specifically configured to perform receiving, thereby improving the receiving current sensitivity by multiple times.

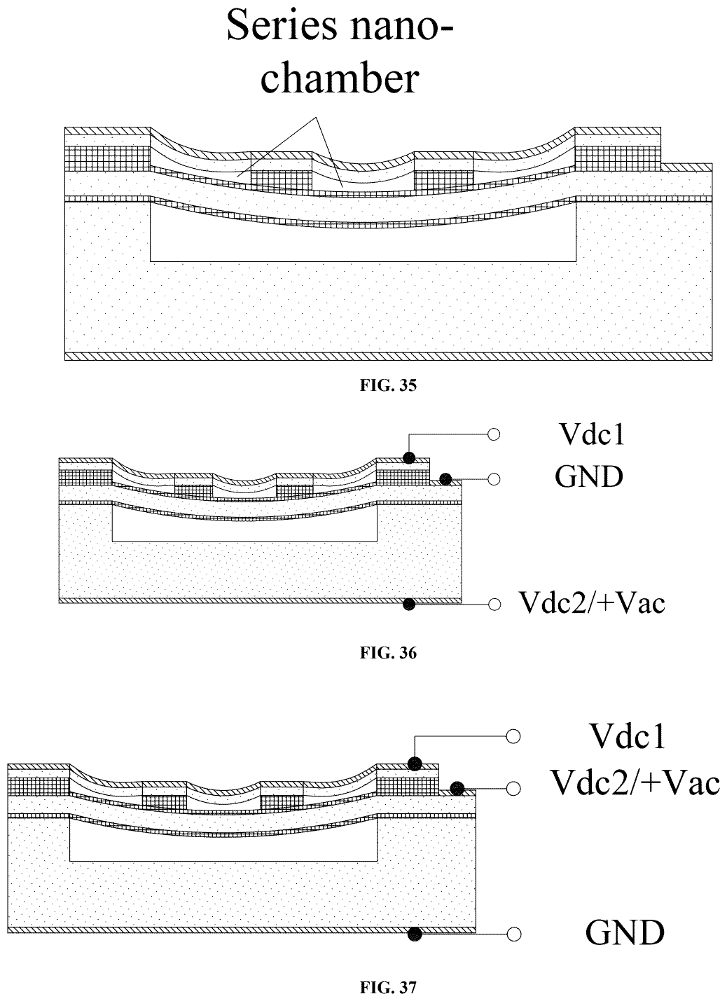

The nano-chambers arranged side by side in various ways. In one example, the plurality of nano-chambers may be transversely arranged side by side. For example, refer to FIG. 35, the plurality of nano-chambers are placed above the main resonant plate (or the micro-chamber), and are transversely arranged side by side.

It should be noted that the horizontal direction herein is the transverse direction (corresponding to FIG. 35, the transverse direction being from left to right or from right to left).

Or, arrangement side by side may also be referred to as arrangement in one row.

In another example, the plurality of nano-chambers arranged side by side are on the upper surface of the main resonant plate, can be arranged in a direction perpendicular to the transverse direction (corresponding to FIG. 35, the direction perpendicular to the transverse direction being a direction perpendicular to a screen), or may be arranged in one row on the main resonant plate.

Or, the plurality of nano-chambers arranged side by side are arranged on the main resonant plate in an array form.

The height of the nano-chambers can be as small as dozens of nanometers in the natural state, to prominently improve the sensitivity and reduce the driving voltage (the sensitivity being inversely proportional to the square of the height of the chamber, and the pull-in voltage being directly proportional to the 1.5th power of the height of the chamber). The height of the micro-chamber can reach a micro-level to prominently increase the resonance amplitude of the plate, thereby increasing the output sound pressure. For example, the receiving plate may be designed into a membrane (i.e., the membrane above), to prominently increase the receiving bandwidth with the stress stiffening effect. The sending plate may be designed into a plate (i.e., the plate above), to reduce the geometric nonlinearity, improve the sending sensitivity and increase the output sound pressure.

Those skilled in the art can flexibly design the number, position and size of the nano-chambers arranged side by side, the thickness of the resonant plate, etc. according to actual requirements, which will not be repeated herein.

The heights of the micro-chamber and nano-chamber and the thickness of the resonant plate of the CMUT with a single nano-chamber are similar to those of the CMUT with a plurality of nano-chambers, and reference may be made.

The nano-chambers arranged side by side can share a pair of lead electrodes, and on the basis of the structure shown in FIG. 35, there are three lead electrodes in total. The three lead electrodes may have a plurality of configuration modes, and the typical multi-lead-electrode configuration is as shown in FIG. 36 and FIG. 37. FIG. 36 shows a multi-lead-electrode in parallel configuration, and FIG. 37 shows a multi-lead-electrode in series configuration.

The parallel configuration of the three lead electrodes is, for example, as follows:
among the three lead electrodes, one lead electrode is shared by the chambers, for example, the lead electrode located in the middle in FIG. 36 is shared by each nano-chamber and the micro-chamber. The common lead electrode can be connected to GND, GND serves as a common negative electrode, and the other lead electrodes may be connected to the positive electrodes of the signals received by the chambers. The received signals may specifically be direct-current bias voltages or driving signals. This part is similar to the embodiments related to FIG. 15, which will not be repeated herein.

The series configuration of the three lead electrodes is, for example, as follows:

Refer to FIG. 37, among a plurality of lead electrodes, the lead electrode located at the bottommost part is connected to GND, and as a common negative electrode, the other lead electrodes are connected to the positive electrodes of the signals received by the corresponding chambers. This part is similar to the embodiments related to FIG. 17, which will not be repeated herein.

In addition, since the nano-chambers are configured to perform receiving, the driving signals do not need to be applied to the nano-chambers.

The multi-lead-electrode configuration increases the degree of freedom in the optimization of the new CMUT. Some electrode configurations can achieve independence of sending and receiving functions, and some electrode configurations can achieve switch-free switching between the sending and receiving modes, thereby eliminating significant heating caused by a conventional electronic switch.

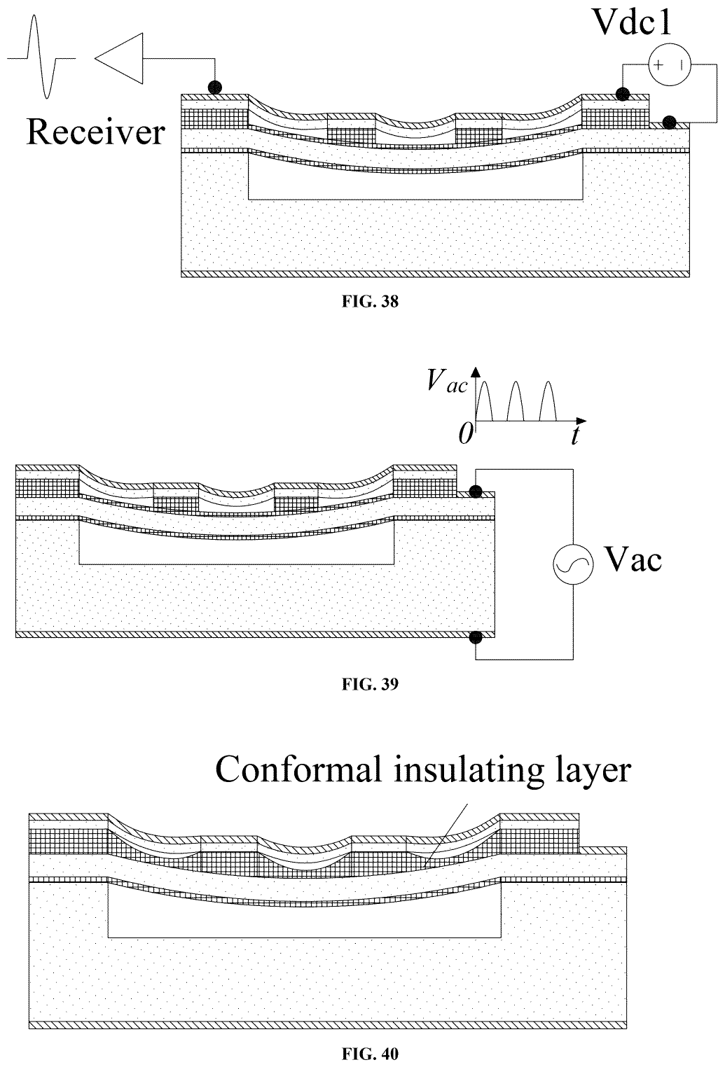

When the novel CMUT receives the ultrasonic signal, as shown in FIG. 38, a bias voltage is applied to the nano-chamber having a membrane. Since the height of the nano-chamber is very small, there is a strong electric field intensity in the chamber, thereby obtaining high sensitivity and low driving voltage. Moreover, due to the stress stiffening effect of the membrane, the receiving chamber has a high receiving bandwidth. when the novel CMUT sends pulses or continuous ultrasonic waves, as shown in FIG. 39, an alternating-current voltage can be applied to the micro-chamber having a plate. Since the height of the micro-chamber is large, the plate may have a large resonance amplitude during resonance, thereby increasing the output sound pressure. The alternating-current signals may be conventional sine waves or continuous pulse sequences. Since the plate has a very small geometric nonlinearity, the sending chamber has a very high sending sensitivity.

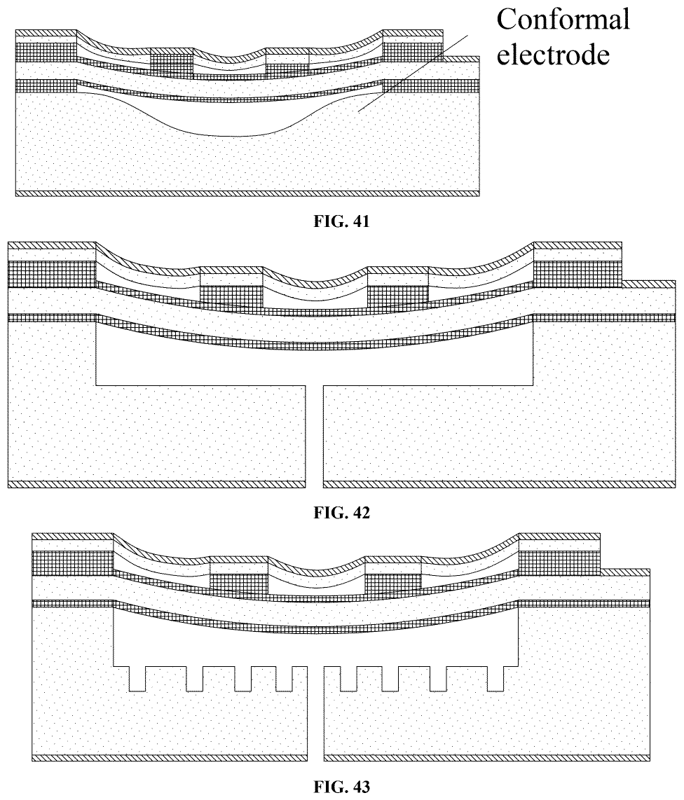

In the CMUT having the micro-nano stacked chamber configuration in all the other embodiments of the present disclosure, at least one of the main resonant plate, the receiving plate and the substrate uses the 3D conformal electrode design, thereby prominently improving the sensitivity and reducing the driving voltage, as shown in FIG. 40 and FIG. 41. Reference may be made to the above descriptions for details, which will not be repeated herein.

It should be noted that refer to FIG. 40, an insulating layer may be provided on the surface of the main resonant plate facing the nano-chamber, and the surface of the insulating layer facing the nano-chamber may be designed into a conformal surface, which has the same shape as the shape of the deformed receiving plate. The insulating layer having a conformal surface may be referred to as a conformal insulating layer or a 3D conformal insulating layer.

The gas squeeze-film damping may be introduced into the CMUT having the micro-nano stacked chamber configuration in all the other embodiments of the present disclosure. Specifically, the introduction may be implemented by providing a through hole on the substrate or providing a through hole or a hollowed structure and a microfluidic channel on the resonant plate, as shown in FIG. 42 to FIG. 44. Reference may be made to the above statements for related descriptions, which will not be repeated herein.

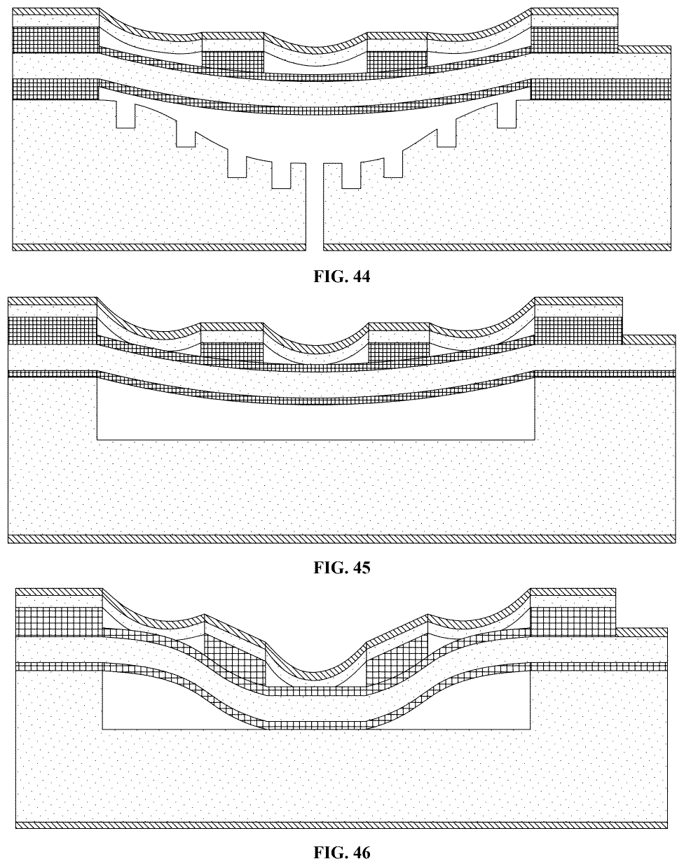

The through hole, hollow and microfluidic channel design mentioned in this embodiment is also applicable to the novel CMUT having a 3D conformal electrode design, as shown in FIG. 44.

The CMUT with a micro-nano stacked chamber proposed in each embodiment can also operate in the collapse mode, as shown in FIG. 45 to FIG. 48. When which chamber needs to be collapse, the direct-current bias voltage applied to the chamber exceeds the pull-in voltage, which will not be repeated herein.

### II, Cascade

The plurality of cascaded nano-chambers can be arranged in the micro-chamber (i.e., dividing the micro-chamber into a plurality of nano-chambers), are configured to perform sending and receiving, and in this case, can implement cascaded receiving or cascaded sending. The plurality of nano-chambers are configured to perform cascaded receiving, and can increase the current and voltage receiving sensitivity by multiple times, to obtain extremely high receiving sensitivity. Cascaded driving of the plurality of nano-chambers increases the resonance amplitude by multiple times and reduces the driving voltage by multiple times, such that an extremely large output sound pressure can be obtained at a low driving voltage. In this way, the output sound pressure and the receiving sensitivity can be amplified by multiple stages, that is, a very large output sound pressure and extremely high receiving sensitivity can be obtained at a very small driving voltage.

In the case of cascaded receiving or sending, the plurality of resonant plates can achieve multiple resonance modes such as the same frequency or different frequencies, to significantly increase the output sound pressure and reduce the dielectric breakdown of the insulating layer.

The plurality of nano-chambers have a plurality of cascade modes. For example, the longitudinal series arrangement shown in FIG. 49 to FIG. 52:

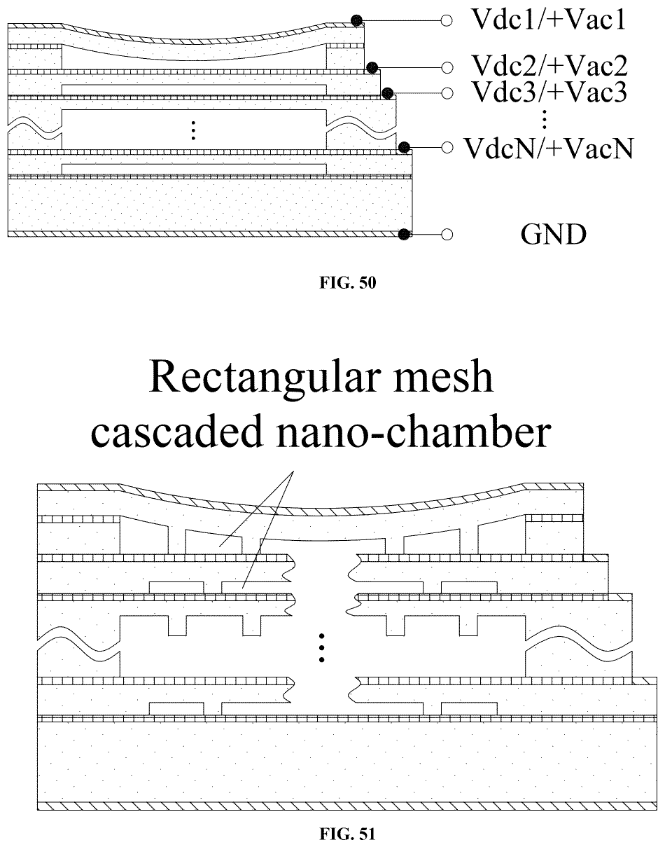

FIG. 49 shows that a micro-chamber is divided longitudinally into a plurality of micro-chambers having a height of tens to hundreds of nanometers. The multi-micro/nano-chamber and multi-lead-electrode cascaded configuration is shown in FIG. 50.

The lead-electrode cascaded configuration shown in FIG. 50 is similar to the series configuration of three lead electrodes above:

The lead electrode located at the bottom of the substrate (i.e., the bottommost part) can be connected to GND to serve as a common negative electrode, and the other lead electrodes (generally being lead electrodes on a certain chamber) are connected to the positive electrodes of signals (direct-current bias voltages or driving signals). Taking a nano-chamber 1 as an example, during signal reception, the lead electrode thereon is connected to (positive electrode or negative electrode of) the direct-current bias voltage Vdc1, and during signal sending, the lead electrode thereon may be connected to (positive electrode or negative electrode of) the alternating-current driving signal or the continuous pulse signal Vac1, or (positive electrode or negative electrode of) Vac and Vdc1. Similarly, when a nano-chamber 2 receives a signal, the lead electrode thereon is connected to (positive electrode or negative electrode of) the direct-current bias voltage Vdc2, and when the nano-chamber 2 sends a signal, the lead electrode thereon is connected to (positive electrode or negative electrode of) the alternating-current driving signal or the continuous pulse signal Vac2, or (positive electrode or negative electrode of) Vac and Vdc2, and so on, which will not be repeated herein.

Or, the lead electrode located at the topmost part can be connected to GND to serve as a common negative electrode, and the other lead electrodes are connected to the positive electrodes of signals (direct-current bias voltages or driving signals). Reference may be made to the above descriptions, which will not be repeated herein.

In the longitudinal cascaded structure, the uppermost nano-chamber may be responsible for receiving, and the micro-chamber is responsible for sending.

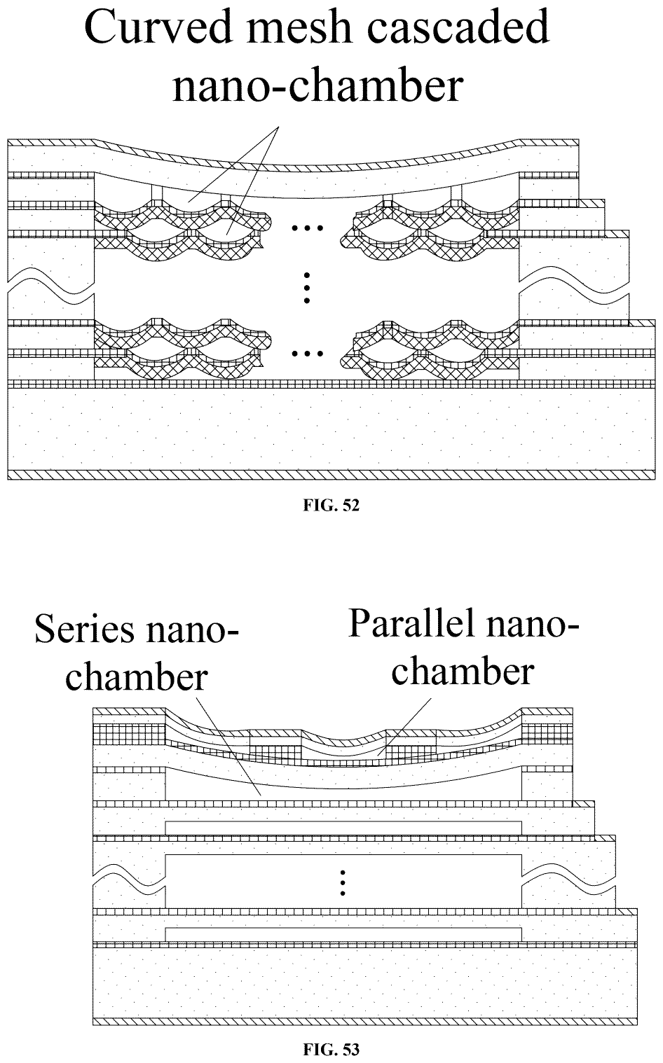

In addition to longitudinal cascade, FIG. 51 and FIG. 52 also respectively show a mesh cascaded arrangement structure in which the micro-chamber is divided into a plurality of nano-chambers. The meshes may be specifically rectangular meshes or curved meshes, the driving voltage is the driving voltage of a single nano-chamber, and the resonance amplitude is the sum of the plurality of cascaded chambers. Or, it can also be seen that the micro-chamber is longitudinally divided into a plurality of layers, each layer includes a plurality of nano-chambers arranged side by side, and one nano-chamber in each layer serves as one mesh.

The nano-chambers in the same layer share a pair of lead electrodes, and the adjacent layers share a lead electrode. Therefore, the electrode configuration of the CMUT of the mesh cascaded structure is similar to the configuration of the CMUT of the longitudinal series structure. Reference may be made to the lead electrode configuration in FIG. 50, which will not be repeated herein.

In the mesh cascaded structure, each nano-chamber is responsible for receiving, and the micro-chamber is responsible for sending.

### III, Side-by-Side and Cascade Hybrid

In this case, some nano-chambers are arranged above the main resonant plate (or the micro-chamber) side by side and are specifically configured to perform receiving; and the remaining nano-chambers are located inside the micro-chamber and are specially configured to perform sending.

FIG. 53 to FIG. 55 show that a plurality of nano-chambers are arranged above the resonant plate side by side for receiving ultrasonic signals, and the micro-chamber is divided into a plurality of micro-chambers for cascaded sending of ultrasonic signals.

Since side-by-side and cascade are included at the same time, the advantages of the side-by-side and the cascade introduced above are also achieved. The electrode configuration may also refer to the descriptions above, which will not be repeated herein.

The CMUT having a micro-nano stacked chamber configuration in all the other embodiments of the present disclosure may use any of the 3D conformal electrode sign, the through hole, the hollow, and the microfluidic channel design mentioned above, which will not be repeated herein.

The following is an introduction to the performance of the novel CMUT having a micro-nano stacked chamber in the normal mode in combination with specific design parameters:

The novel CMUT structure is as shown in FIG. 39, and the operating frequency thereof is set to be 5.0 MHz; the sizes of the micro-chamber and each nano-chamber are respectively 224 μm and 72 μm; and three nano-chambers are arranged side by side. To reduce the geometric nonlinearity and improve the sending sensitivity, 20 μm thick silicon is selected to serve as a sending resonant plate of the micro-chamber. To improve the receiving sensitivity and increase the bandwidth, 2 μm thick silicon is selected to serve as a receiving resonant plate of each nano-chamber. The height of the micro-chamber is 0.2 μm to obtain a reasonable driving voltage, and the height of the nano-chambers is 100 nm.

Under the above parameter design, the pull-in voltage of the micro-chamber in the novel CMUT is 152.8 V. Upon comparison, the pull-in voltage of the nano-chambers is only 7.8 V, which is increased by nearly 20 times.

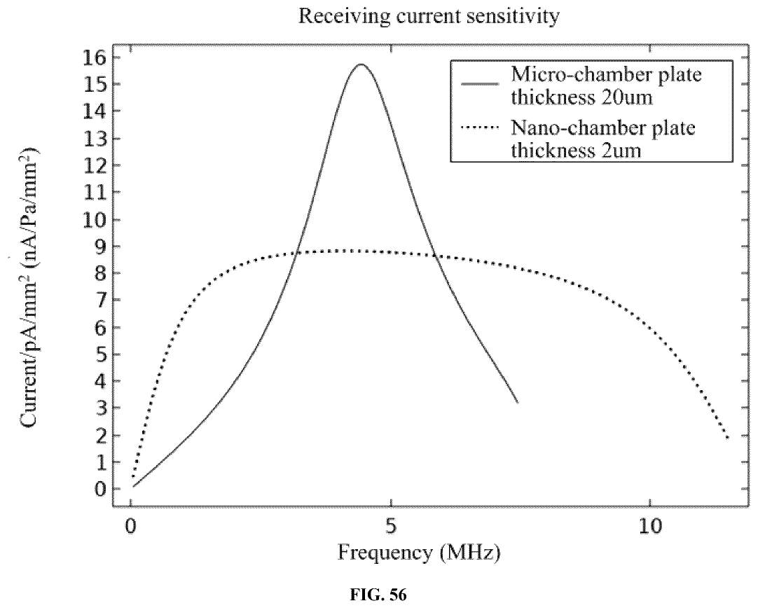

The receiving sensitivities of the micro-chamber and the nano-chambers are as shown in FIG. 56. It should be noted that looking back at FIG. 29 and FIG. 30, it can be found that the trends of the receiving sensitivity and the sending sensitivity are the same, and are almost in the same proportion, because the chambers work in all small signal models, and other geometric dimensions such as the chamber height are fixed, and are basically only related to the driving voltage. Therefore, although FIG. 56 shows a receiving sensitivity curve, the curve can also represent the trend of the sending sensitivity.

The micro-chamber serves as a sending chamber, and the core performance thereof, i.e., sending sensitivity, is significantly improved. The nano-chamber has a bandwidth of 232%, which is nearly 5 times higher than the 46% of the micro-chamber. The bandwidth herein is a percentage bandwidth, which is the percentage of the actual 3 dB (½ of the maximum amplitude) bandwidth to the center frequency. The significant increase of the bandwidth is expected to enable the CMUT to receive harmonic signals two times or even three times, thereby significantly improving imaging resolution and the imaging quality.

In terms of the sensitivity per unit area, the nano-chamber only loses 44% compared to the conventional CMUT with micro-chamber geometric features. Therefore, the sensitivity-bandwidth product is improved by 2.8 times overall.

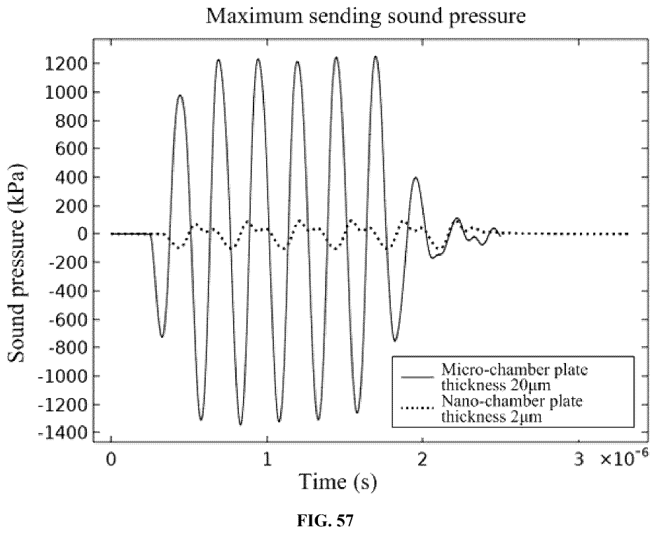

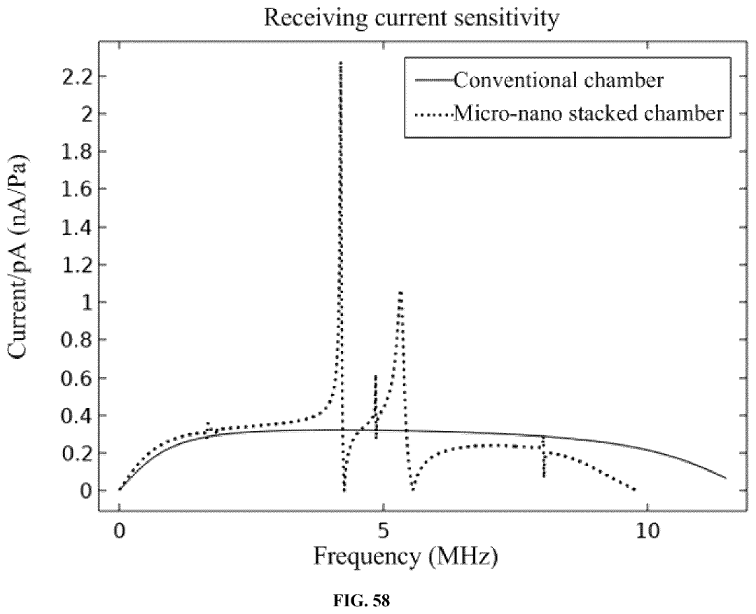

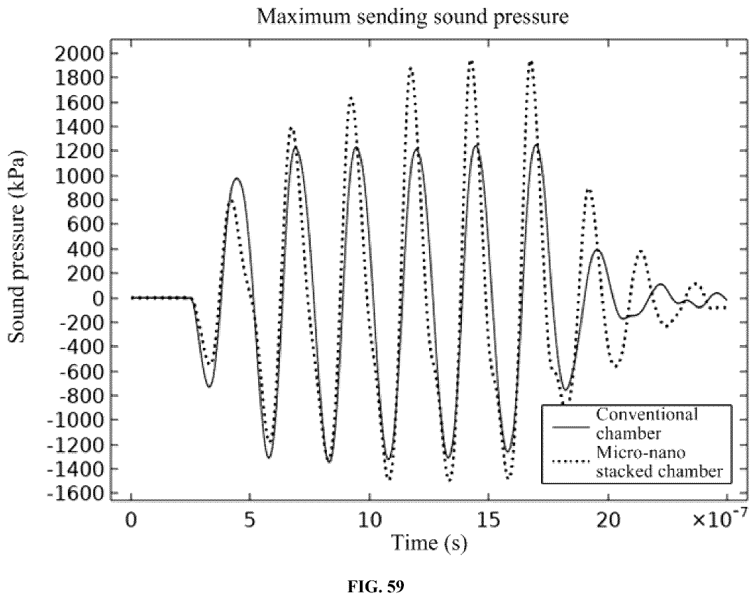

FIG. 57 shows the sending characteristics of the micro-chamber and the nano-chambers. Obviously, the micro-chamber having a thick resonant plate will obtain a higher output sound pressure. The receiving sensitivity (which can also represent the sending sensitivity) and the output sound pressure after a plurality of nano-chambers are coupled to a single micro-chamber are shown in FIG. 58 and FIG. 59. In view of the above, the novel CMUT provided in this embodiment has significantly improved receiving/sending sensitivity and output sound pressure compared to the conventional CMUT.

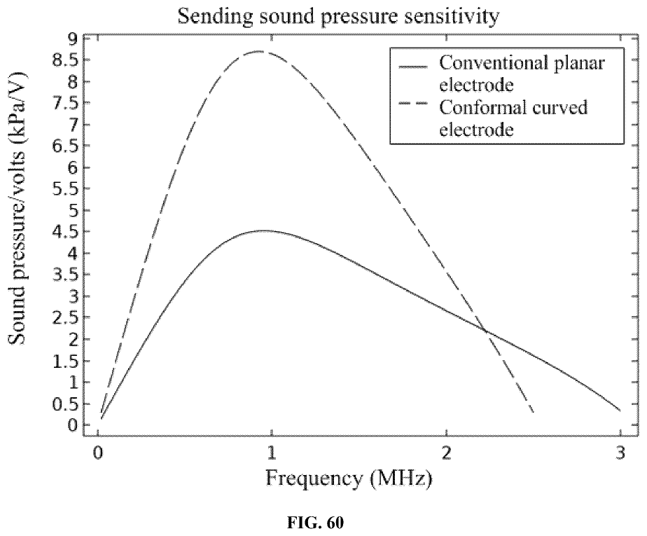

In addition, FIG. 60 also shows a sensitivity comparison between the conventional planar electrode and the substrate having a 3D curved conformal electrode after the substrate uses a 3D conformal surface (specifically a curved surface) on the structure shown in FIG. 39.

The receiving sensitivity and the maximum output sound pressure are the conflicting core performance indicators of the existing single-plate single-chamber CMUT design. Upon comparison, the significant advantage of the novel CMUT design having a micro-nano stacked chamber configuration proposed in the embodiments of the present disclosure is to obtain large receiving sensitivity and bandwidth with a relatively small driving voltage, while increasing the maximum output sound pressure. Compared with the conventional CMUT, the driving voltage is reduced by nearly 20 times, the sensitivity-bandwidth product is improved by 2.8 times or above, and the maximum output sound pressure is increased by at least 40% or above.

The novel CMUT having a micro-nano stacked chamber configuration at least has the following advantages:
1) The receiving sensitivity and the bandwidth are prominently improved, the harmonic signals can be synchronously received for multiple times, the imaging resolution and the imaging quality are improved, the output sound pressure is increased, and a low driving voltage is maintained;
2) A plurality of nano-chambers can implement multi-stage cascaded receiving or multi-stage cascaded driving, and can obtain extremely high sensitivity and extremely large output sound pressure at a very small driving voltage;
3) The multi-lead-electrode configuration can implement switch-free switching between the sending and receiving modes, thereby eliminating significant heating caused by a conventional electronic switching, the 3D conformal electrode design further improves the sensitivity and reduces the driving voltage, and the gas squeeze-film damping design can be introduced to further increase the bandwidth and regulate dynamic characteristics.

The control method for the novel CMUT is introduced below, which at least includes the following steps:
S1: during signal reception, provide a direct-current bias voltage at least to a chamber (receiving chamber) configured to receive an ultrasonic signal.

Reference may be made to the above descriptions for the direct-current bias voltage, which will not be repeated herein.

The direct-current bias voltage is mainly configured to make the two lead electrodes of the receiving chamber have electric charges. The external ultrasonic waves can make the resonant plates vibrate, causing the capacitance between the resonant plates (lead electrodes) to change, and also causing the flow of the electric charges to generate a current.

Therefore, the purpose of applying the direct-current bias voltage to the receiving chamber is to extract the received signal. Moreover, the larger the direct-current bias voltage is, the greater the deformation of the corresponding resonant plate is, such that the interval between two adjacent resonant plates (or resonant plates and lead electrodes) is smaller, the electric field strength is greater, and the output current signal strength is also greater.
S2: during signal sending, provide a driving signal at least to a chamber (sending chamber) configured to send the ultrasonic signal.

Reference is made to the above descriptions for the driving signal, which will not be repeated herein.

In some examples, providing the driving signal to the sending chamber may specifically include: provide a continuous pulse sequence to the sending chamber to serve as the driving signal.

As mentioned above, in the scenario of receiving an ultrasonic signal, the chamber with a relatively small height in the natural state or after deformation may serve as a receiving chamber, and in the scenario of sending the ultrasonic signal, the chamber with a relatively large height in the natural state or after deformation may serve as a sending chamber.

That is, for reception, the plurality of chambers included in the novel CMUT can satisfy:
the height of at least one chamber in the natural state is not less than the height of the receiving chamber in the natural state (for example, the height of the micro-chamber in the natural state is greater than that of the nano-chamber serving as the receiving chamber);
or, during signal reception, the height of the receiving chamber is smaller than the height of the receiving chamber in the natural state due to the deformation of the resonant plate (for example, in the CMUT shown in FIG. 6, when the main chamber receives a signal, the height of the main chamber is smaller than the height of the main chamber in the natural state shown in FIGS. 2A-2B).

Or, the plurality of chambers included in the novel CMUT also satisfy: the height of at least one chamber in the natural state is not less than the height of the chamber in the natural state, and, during signal reception, the height of the receiving chamber is less than the height of the receiving chamber in the natural state due to the deformation of the resonant plate. For example, the height of the micro-chamber in the natural state is greater than that of the nano-chamber serving as the receiving chamber. During operation, refer to FIG. 45, the resonant plate at the top of the nano-chamber collapses towards the micro-chamber, and at this time, the height of the nano-chamber is less than the height of the nano-chamber in the natural state.

For sending, the plurality of chambers included in the novel CMUT can satisfy:
the height of at least one chamber in the natural state is not greater than the height of the sending chamber in the natural state (for example, the height of the nano-chamber of the CMUT shown in FIG. 34 in the natural state is less than that of the micro-chamber serving as the sending chamber);
or, during signal sending, the height of the sending chamber is greater than the height of the sending chamber in the natural state due to the deformation of the resonant plate (for example, in the CMUT shown in FIG. 22, when the main chamber sends a signal, the height of the main chamber is greater than the height of the main chamber in the natural state shown in FIGS. 2A-2B).

Or, the plurality of chambers included in the novel CMUT also satisfy: the height of at least one chamber in the natural state is not greater than the height of the sending chamber in the natural state, and, during signal sending, the height of the sending chamber is greater than the height of the sending chamber in the natural state due to the deformation of the resonant plate.

In the other embodiments of the present disclosure, the height of the receiving chamber being less than the height of the receiving chamber in the natural state at least can be implemented through the following mode:
provide to the receiving chamber a direct-current bias voltage that enables the resonant plate at the top of the receiving chamber to deform, such that the resonant plate at the top of the receiving chamber protrudes towards the bottom of the receiving chamber, and the height of the receiving chamber decreases. Taking FIG. 13 as an example, a certain direct-current bias voltage can be applied to the main chamber, such that the main resonant plate protrudes downwards, and the height of the main chamber decreases.

In the other embodiments of the present disclosure, the height of the sending chamber being greater than the height of the sending chamber in the natural state can be implemented through the following mode:
provide a direct-current bias voltage to a chamber adjacent to the lower side of the sending chamber, such that the resonant plate at the top of the adjacent chamber protrudes away from the top of the sending chamber, the height of the adjacent chamber decreases, and the height of the sending chamber increases.

For example, refer to FIG. 16, the main chamber may serve as the receiving chamber, and the direct-current bias voltage Vdc2 is applied to the auxiliary chamber, such that the slave resonant plate has a certain downward displacement bias (deformation).

To sum up, the remarkable advantage of the technical solution provided by the present disclosure includes, but is not limited to:
(1) the output sound pressure is prominently increased; (2) high receiving sensitivity and (3) low driving voltage are maintained; (4) the multi-chamber structure implements height adjustment or physical separation of the sending and/or receiving chamber, such that the sending and receiving functions are independent, and the maximum output sound pressure and the optimal receiving sensitivity are obtained at a low driving voltage; (5) the micro/nano-chamber configuration can prominently improve the sending sensitivity and increase the receiving bandwidth; (6) the nano-chamber multistage linkage configuration can achieve an extremely low driving voltage, an extremely large output sound pressure and extremely high receiving sensitivity; (7) the plurality of resonant plates resonate at the same frequency or different frequencies, thereby significantly increasing the output sound pressure and reducing the dielectric breakdown of the insulating layer; (8) the multi-lead-electrode configuration implements switch-free switching between the sending and receiving modes, thereby eliminating significant heating caused by a conventional electronic mode switching; (9) the multi-lead-electrode configuration implements differential signal readout, thereby prominently increasing the SNR of the received signal; (10) the 3D conformal electrode design can be implemented to prominently improve the sensitivity and reduce the driving voltage; (11) the gas squeeze-film damping design can be introduced to regulate the bandwidth and restrain harmonic waves; (12) the novel continuous pulse sequence driving signals can be applied to further increase the output sound pressure; and (13) the CMUT can operate in the collapse mode to further improve the output sound pressure and the sensitivity.

The embodiments are described herein in a progressive manner. Each embodiment focuses on the difference from another embodiment, and the same and similar parts between the embodiments may refer to each other.

Specific examples are used herein for illustration of the principles and embodiments of the present disclosure. The description of the foregoing embodiments is used to help understand the method of the present disclosure and the core principles thereof. In addition, those of ordinary skill in the art can make various modifications in terms of specific embodiments and scope of application in accordance with the teachings of the present disclosure. In conclusion, the content of the description shall not be construed as limitations to the present disclosure.

What is claimed is:

1. A novel capacitive micromachined ultrasonic transducer (CMUT), comprising a substrate, a plurality of chambers provided on the substrate, and a plurality of resonant plates, wherein the resonant plate is at least disposed at a top of each chamber, upper and lower adjacent chambers share a resonant plate, at least two of the plurality of chambers have different heights in a natural state, and/or, at least one of the resonant plates shared by the upper and lower adjacent chambers is capable of deforming.

2. The novel CMUT according to claim 1, wherein the plurality of chambers comprise a micro-chamber and a nano-chamber.

3. The novel CMUT according to claim 2, wherein there are a plurality of nano-chambers, and at least some of the plurality of nano-chambers are arranged side by side or cascaded.

4. The novel CMUT according to claim 3, wherein
the nano-chambers arranged side by side are configured to receive ultrasonic signals and are disposed above the resonant plate at the top of the micro-chamber, and/or, the cascaded nano-chambers are configured to send the ultrasonic signals and are disposed below the resonant plate at the top of the micro-chamber.

5. The novel CMUT according to claim 3, wherein
the nano-chambers arranged side by side are transversely arranged side by side; and
the cascaded nano-chambers are longitudinally connected in series and are cascaded in rectangular meshes or curved meshes.

6. The novel CMUT according to claim 1, wherein
the plurality of chambers comprise a main chamber and an auxiliary chamber;
the resonant plate at a top of the main chamber is a main resonant plate; the resonant plate at a top of the auxiliary chamber is a slave resonant plate; and
the main chamber supports to send and receive an ultrasonic signal.

7. The novel CMUT according to claim 1, wherein at least one surface of at least one resonant plate is a conformal surface.

8. The novel CMUT according to claim 1, wherein an electrode provided on an upper surface of the substrate has a conformal surface, and/or, at least a part of the upper surface of the substrate is a conformal surface.

9. The novel CMUT according to claim 7, wherein the conformal surface comprises a three-dimensional curved surface, multiple steps, a slope, or a combined structure, and the combined structure is a combination of at least one of the three-dimensional curved surface, the multiple steps, and the slope.

10. The novel CMUT according to claim 1, wherein the substrate is provided with one or more through holes, and/or, a part of the substrate located in the chamber is provided with a microfluidic channel.

11. The novel CMUT according to claim 1, wherein at least one of the resonant plates is provided with one or more through holes; or, at least one of the resonant plates is of a hollowed structure.

12. The novel CMUT according to claim 1, wherein each chamber corresponds to a pair of lead electrodes, and every two adjacent chambers share a same lead electrode.

13. The novel CMUT according to claim 12, wherein
when the novel CMUT is configured to receive a signal, a pair of lead electrodes corresponding to a receiving chamber is respectively connected to a positive electrode and a negative electrode of a direct-current bias voltage, and the receiving chamber is a chamber for receiving a signal among the plurality of chambers; and
when the novel CMUT is configured to send a signal, a pair of lead electrodes corresponding to a sending chamber is respectively connected to a positive electrode and a negative electrode of a driving signal, wherein
the driving signal is an alternating-current driving signal, or a signal obtained after the alternating-current driving signal is subjected to direct-current bias, or a continuous pulse signal, or a signal obtained after the continuous pulse signal is subjected to direct-current bias.

14. The novel CMUT according to claim 13, wherein
the lead electrode shared by the plurality of chambers is grounded and serves as negative electrodes of signals respectively received by the adjacent chambers, and the signal received by any chamber is a driving signal or a direct-current bias voltage; and
other lead electrodes are connected to a positive electrode of the signal received by the any chamber.

15. The novel CMUT according to claim 13, wherein
among the plurality of lead electrodes comprised in the novel CMUT, a lead electrode located at a bottommost part or a topmost part is grounded and serves as a common negative electrode, and other lead electrodes are connected to positive electrodes of signals received by the chambers to which the other lead electrodes belong; and
the signal received by any chamber is a driving signal or a direct-current bias voltage.

16. The novel CMUT according to claim 13, wherein
two adjacent chambers are both configured to receive signals, and a pair of lead electrodes corresponding to each of the two adjacent chambers is connected to the direct-current bias voltage.

17. The novel CMUT according to claim 13, wherein
two adjacent chambers are both configured to send signals, and a pair of lead electrodes corresponding to each of the two adjacent chambers is connected to the driving signal.

18. The novel CMUT according to claim 13, wherein
when the novel CMUT operates in a collapse mode, at least one of the plurality of chambers is in a collapse state,
wherein
if the chamber in the collapse state serves as a receiving chamber, the direct-current bias voltage connected to the chamber is specifically a collapse driving direct-current voltage; and
if the chamber in the collapse state serves as a sending chamber, the driving signal connected to a pair of lead electrodes corresponding to the chamber is: a signal obtained after the alternating-current driving signal and the collapse driving direct-current voltage are superimposed, or a signal obtained after the continuous pulse signal and the collapse driving direct-current voltage are superimposed.

19. A control method for a novel CMUT, wherein on the basis of the novel CMUT according to claim 1,
the control method comprises:
during signal reception, providing a direct-current bias voltage at least to a chamber configured to receive an ultrasonic signal, wherein the chamber configured to receive the ultrasonic signal is a receiving chamber, and among the plurality of chambers, a height of at least one chamber in a natural state is not less than a height of the receiving chamber in the natural state, and/or, during signal reception, the height of the receiving chamber is less than the height of the receiving chamber in the natural state due to deformation of the resonant plate; and
during signal sending, providing a driving signal at least to a chamber configured to send an ultrasonic signal, wherein the chamber configured to send the ultrasonic signal is a sending chamber, and among the plurality of chambers, the height of at least one chamber in the natural state is not greater than a height of the sending chamber in the natural state, and/or, during signal sending, the height of the sending chamber is greater than the height of the sending chamber in the natural state due to deformation of the resonant plate.

20. The novel CMUT according to claim 8, wherein the conformal surface comprises a three-dimensional curved surface, multiple steps, a slope, or a combined structure, and the combined structure is a combination of at least one of the three-dimensional curved surface, the multiple steps, and the slope.
